(19) United States
(12) Patent Application Publication
(10) Pub. No.: US 2024/0201680 A1
(43) Pub. Date: Jun. 20, 2024

(54) SYSTEMS AND METHODS FOR DISPLAYING RENEWABLE ENERGY ASSET HEALTH RISK INFORMATION

(71) Applicant: Utopus Insights, Inc., Valhalla, NY (US)

(72) Inventor: Kim Fluchel, Pittstown, NJ (US)

(73) Assignee: Utopus Insights, Inc., Valhalla, NY (US)

(21) Appl. No.: 18/540,452

(22) Filed: Dec. 14, 2023

Related U.S. Application Data
(60) Provisional application No. 63/387,861, filed on Dec. 16, 2022.

(51) Int. Cl. G05B 23/02; G06Q 10/0631; G06Q 10/20

(52) U.S. Cl. CPC G05B 23/0272; G06Q 10/06313; G06Q 10/20; G05B 2223/06

(57) ABSTRACT

An example method comprises receiving sensor data from multiple wind turbines. A wind turbine includes a gearbox, a generator, and multiple gearbox and generator subcomponents. Health indicators may be determined for the gearbox and generator subcomponents with varying lead times. The health indicators correspond to alerts for current or predicted problems of the gearbox and generator subcomponents and have either low severity, medium severity, or high severity risk levels. A machine learning model trained on sensor data may generate the alerts. The multiple wind turbines may be displayed in a list that may be sortable by health indicators for the gearbox subcomponents and the generator subcomponents. The list may be filterable by alerts for the gearbox subcomponents or the generator subcomponents.

### CROSS-REFERENCE TO RELATED APPLICATIONS

This application claims priority to and seeks the benefit of U.S. Provisional Patent Application No. 63/387,861, filed on Dec. 16, 2022 and entitled “Systems and Methods for Displaying Renewable Energy Asset Health Risk Information,” which is incorporated in its entirety herein by reference.

### FIELD OF THE INVENTION(S)

Embodiments of the present invention(s) relate generally to user interfaces for displaying risk of failure or damage of renewable energy assets and, in particular, to user interfaces for displaying risk of failure or damage of renewable energy assets that are forecasted with varying lead time before failure.

### BACKGROUND

Renewable energy assets (e.g., a wind turbine) are becoming increasingly common. For example, wind farms located in remote portions of the world include tens to hundreds of renewable energy assets. Unfortunately, a renewable energy asset includes many components that, if they fail, will render the asset inoperable until fixed.

Due to the large number of components of each renewable energy asset, the number of renewable energy assets, the distribution of the assets, and remote locations, it is very difficult to predict likelihood of failures. Moreover, is difficult to target the maintenance or repair work to be done on a renewable energy asset prior to catastrophic failure.

Generally, utilities merely wait until devices fail. Once a particular asset reaches the point of failure, the failure of one component may cause stresses and damage to other parts of the asset. As a result, a certain number of expensive wind turbines are lost.

### SUMMARY

An example non-transitory computer readable medium comprises executable instructions. The executable instructions are executable by one or more processors to perform a method, the method comprising: receiving first current sensor data of a first time period from multiple wind turbines in one or more wind turbine farms in one or more geographies, a wind turbine including a gearbox and a generator, the gearbox including a first gearbox bearing subcomponent, a gear set subcomponent, and a second gearbox bearing subcomponent, and the generator including a first generator bearing subcomponent, a rotor subcomponent, and a second generator bearing subcomponent; the first current sensor data including sensor data from sensors monitoring the gearbox subcomponents and the generator subcomponents, determining health indicators for the gearbox subcomponents, the health indicators corresponding to alerts for current or predicted problems of the gearbox subcomponents with varying lead time, the alerts including a low severity risk alert, a medium severity risk alert, and a high severity risk alert, the alerts being generated by a machine learning model trained on second historical sensor data of a second time period, including sensor data from the gearbox subcomponents, determining health indicators for the generator subcomponents, the health indicators corresponding to alerts for current or predicted problems of the generator subcomponents with varying lead time, the alerts including a low severity risk alert, a medium severity risk alert, and a high severity risk alert, the alerts being generated by a machine learning model trained on second historical sensor data of a second time period, including sensor data from sensors monitoring the generator subcomponents, receiving the health indicators for the gearbox subcomponents and the health indicators for the generator subcomponents, and displaying a list of the multiple wind turbines, the health indicators for the gearbox subcomponents and the health indicators for the generator subcomponents, the list being sortable by health indicators for the gearbox subcomponents and/or by the health indicators for the generator subcomponents, and the list being filterable by alerts for the gearbox subcomponents and/or alerts for the generator subcomponents.

In various embodiments, the method further comprises receiving a selection to filter the list of the multiple wind turbines by one or more alerts for at least one gearbox subcomponent and/or for at least one generator subcomponent, filtering the list of the multiple wind turbines to include wind turbines with the selected one or more alerts for at least one gearbox subcomponent and/or for at least one generator subcomponent, and displaying in the list wind turbines with the selected one or more alerts for at least one gearbox subcomponent and/or for at least one generator subcomponent.

In various embodiments, the method further comprises receiving a selection of a wind turbine, the wind turbine having a health indicator for a gearbox subcomponent or a generator subcomponent corresponding to either a low severity risk alert, a medium severity risk alert, or a high severity risk alert, receiving alert status and date information for the gearbox subcomponent or the generator subcomponent of the wind turbine, and displaying the health indicator, the alert status and the date information for the gearbox subcomponent or the generator subcomponent of the wind turbine.

In various embodiments, the method further comprises receiving a selection of the gearbox of the wind turbine, determining an overall health indicator of the gearbox, the overall health indicator based at least in part upon any alerts for the gearbox subcomponents, displaying the overall health indicator of the gearbox, determining an overall health indicator of the generator, the overall health indicator based at least in part upon any alerts for the generator subcomponents, and displaying the overall health indicator of the generator.

In various embodiments, the method further comprises receiving a request to initiate a work order for the gearbox subcomponent or the generator subcomponent of the wind turbine and sending the work order to a work order system.

In various embodiments, the method further comprises receiving completed service events for the wind turbine for a third historical time period the completed service events including completion date and service detail information, receiving open service events for the wind turbine for a fourth future time period; the open service events including date and service detail information, and displaying either the completed service events or the open service events.

In various embodiments, the method further comprises receiving a selection of the gearbox or the generator, determining which gearbox subcomponents or generator subcomponents are monitored by sensors and which gearbox subcomponents or generator subcomponents are not monitored by sensors, displaying a list of the gearbox subcomponents or generator subcomponents, for the gearbox subcomponents or generator subcomponents that are monitored by sensors, the health indicators for the gearbox subcomponents or generator subcomponents, and for the gearbox subcomponents or generator subcomponents that are not monitored by sensors, indications that the gearbox subcomponents or generator subcomponents are not monitored by sensors, and displaying a cross-sectional outline view of the outline of the gearbox or generator, the outlines of the gearbox subcomponents or generator subcomponents, the health indicators of the gearbox subcomponents or generator subcomponents that are monitored by sensors, and the indications that the gearbox subcomponents or generator subcomponents are not monitored by sensors.

In various embodiments, the method further comprises determining a status of the selected wind turbine, receiving the status of the wind turbine, and displaying on a zoomable and scrollable map an icon for the selected wind turbine and an indication of the status of the selected wind turbine.

In various embodiments, the method further comprises receiving a selection of a gearbox subcomponent alert or a generator subcomponent alert, receiving time series data for the selected gearbox subcomponent, displaying the time series data in one or more data charts, receiving a request to display one or more service events for the wind turbine; and displaying the one or more service events overlaid on the time series data in the one or more data charts.

In various embodiments, the method further comprises receiving a request to analyze data for the wind turbine, the data including one or more of temperature data, signals data, CMS data, and vibration data, receiving one or more of the temperature data, signals data, CMS data, and vibration data, and displaying an analysis of the one or more temperature data, signals data, CMS data, and vibration data.

In various embodiments, the method further comprises receiving a request to display the multiple wind turbines in one or more wind turbine farms in one or more geographies in a map, displaying a map of the multiple wind turbines in one or more wind turbine farms in one or more geographies, receiving status, performance deviation and/or active alerts for the multiple wind turbines, and displaying status, performance deviation and/or active alerts for the multiple wind turbines grouped by the one or more wind turbine farms.

An example system may comprise at least one processor and memory containing instructions, the instructions being executable by the at least one processor to: receive first current sensor data of a first time period from multiple wind turbines in one or more wind turbine farms in one or more geographies, a wind turbine including a gearbox and a generator, the gearbox including a first gearbox bearing subcomponent, a gear set subcomponent, and a second gearbox bearing subcomponent, and the generator including a first generator bearing subcomponent, a rotor subcomponent, and a second generator bearing subcomponent; the first current sensor data including sensor data from sensors monitoring the gearbox subcomponents and the generator subcomponents, determine health indicators for the gearbox subcomponents, the health indicators corresponding to alerts for current or predicted problems of the gearbox subcomponents with varying lead time, the alerts including a low severity risk alert, a medium severity risk alert, and a high severity risk alert, the alerts being generated by a machine learning model trained on second historical sensor data of a second time period, including sensor data from the gearbox subcomponents, determine health indicators for the generator subcomponents, the health indicators corresponding to alerts for current or predicted problems of the generator subcomponents with varying lead time, the alerts including a low severity risk alert, a medium severity risk alert, and a high severity risk alert, the alerts being generated by a machine learning model trained on second historical sensor data of a second time period, including sensor data from sensors monitoring the generator subcomponents, receive the health indicators for the gearbox subcomponents and the health indicators for the generator subcomponents, and display a list of the multiple wind turbines, the health indicators for the gearbox subcomponents and the health indicators for the generator subcomponents, the list being sortable by health indicators for the gearbox subcomponents and/or by the health indicators for the generator subcomponents, and the list being filterable by alerts for the gearbox subcomponents and/or alerts for the generator subcomponents.

An example method comprises receiving first current sensor data of a first time period from multiple wind turbines in one or more wind turbine farms in one or more geographies, a wind turbine including a gearbox and a generator, the gearbox including a first gearbox bearing subcomponent, a gear set subcomponent, and a second gearbox bearing subcomponent, and the generator including a first generator bearing subcomponent, a rotor subcomponent, and a second generator bearing subcomponent, the first current sensor data including sensor data from sensors monitoring the gearbox subcomponents and the generator subcomponents, determining health indicators for the gearbox subcomponents, the health indicators corresponding to alerts for current or predicted problems of the gearbox subcomponents with varying lead time, the alerts including a low severity risk alert, a medium severity risk alert, and a high severity risk alert, the alerts being generated by a machine learning model trained on second historical sensor data of a second time period, including sensor data from the gearbox subcomponents, determining health indicators for the generator subcomponents, the health indicators corresponding to alerts for current or predicted problems of the generator subcomponents with varying lead time, the alerts including a low severity risk alert, a medium severity risk alert, and a high severity risk alert, the alerts being generated by a machine learning model trained on second historical sensor data of a second time period, including sensor data from sensors monitoring the generator subcomponents, receiving the health indicators for the gearbox subcomponents and the health indicators for the generator subcomponents, and displaying a list of the multiple wind turbines, the health indicators for the gearbox subcomponents and the health indicators for the generator subcomponents, the list being sortable by health indicators for the gearbox subcomponents and/or by the health indicators for the generator subcomponents, and the list being filterable by alerts for the gearbox subcomponents and/or alerts for the generator subcomponents.

### BRIEF DESCRIPTION OF THE DRAWINGS

In the drawings, wherein like reference characters denote corresponding or similar elements throughout the various figures:

FIG. 1 depicts a block diagram of an example of an electrical network in some embodiments.

FIG. 2 is a block diagram of a renewable energy asset monitoring system in some embodiments.

FIG. 3A depicts a summary user interface for a renewable energy asset monitoring system in some embodiments.

FIG. 3B depicts a Health Overview card of a summary user interface for a renewable energy asset monitoring system in some embodiments.

FIG. 3C depicts an Active Alerts card of a summary user interface for a renewable energy asset monitoring system in some embodiments.

FIG. 4A depicts a turbine details user interface for a renewable energy asset monitoring system in some embodiments.

FIG. 4B depicts an alert details user interface for a renewable energy asset monitoring system in some embodiments.

FIG. 5A depicts multiple cards of a turbine component details user interface for a renewable energy asset monitoring system in some embodiments.

FIG. 5B depicts multiple cards of a turbine component details user interface for a renewable energy asset monitoring system in some embodiments.

FIG. 5C depicts a Monitoring Details card of a turbine component details user interface for a renewable energy asset monitoring system in some embodiments.

FIG. 6A depicts multiple cards of an analysis user interface for a renewable energy asset monitoring system in some embodiments.

FIG. 6B depicts multiple cards of an analysis user interface for a renewable energy asset monitoring system in some embodiments.

FIG. 6C depicts example health tracker data that may be present in the Health Tracker card depicted in FIG. 6B in some embodiments.

FIG. 7A depicts a map user interface for a renewable energy asset monitoring system in some embodiments.

FIG. 7B depicts a map user interface for a renewable energy asset monitoring system in some embodiments.

FIG. 8 depicts an account user interface for a renewable energy asset monitoring system in some embodiments.

FIG. 9 depicts an email alert notification user interface for a renewable energy asset monitoring system in some embodiments.

FIG. 10A depicts a configure alert user interface for a renewable energy asset monitoring system in some embodiments.

FIG. 10B depicts a create alert user interface for a renewable energy asset monitoring system in some embodiments.

FIG. 11 depicts three flowcharts for reliability management for a renewable energy asset monitoring system in some embodiments.

FIG. 12 is a flowchart for displaying health indicators for components and/or subcomponents of a renewable energy asset in some embodiments.

FIG. 13 depicts example phases of operation for risk prediction in some embodiments.

FIG. 14 is a flowchart for predicting failures and/or potential failures of renewable energy assets in some embodiments.

FIG. 15 is a flowchart for wind turbine failure forecasting using SCADA alarms and event logs in some embodiments.

FIG. 16 characterizes problems and proposes solutions in some embodiments.

FIG. 17 depicts a block diagram of an example digital device in some embodiments.

### DETAILED DESCRIPTION

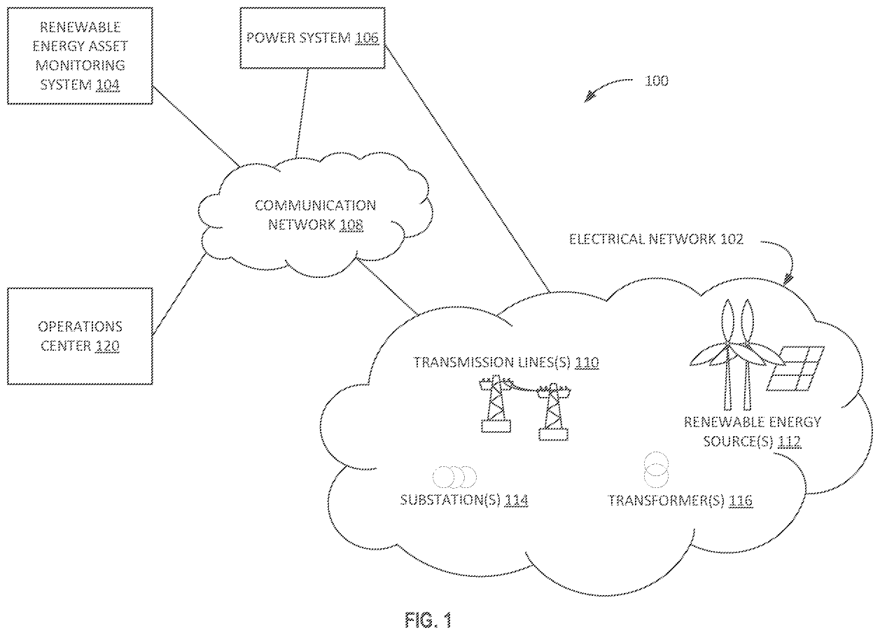

FIG. 1 depicts a block diagram 100 of an example of an electrical network 102 in some embodiments. FIG. 1 includes an electrical network 102, a renewable energy asset monitoring system 104, a power system 106, and operations center(s) 120 in communication over a communication network 108. The electrical network 102 includes any number of transmission line(s) 110, renewable energy source(s) 112, substation(s) 114, and transformer(s) 116. The electrical network 102 may include any number of electrical assets including protective assets (e.g., relays or other circuits to protect one or more assets), transmission assets (e.g., lines, or devices for delivering or receiving power), and/or loads (e.g., residential houses, commercial businesses, and/or the like).

Components of the electrical network 102 such as the transmission line(s) 110, the renewable energy source(s) 112, substation(s) 114, and/or transformer(s) 116 may inject energy or power (or assist in the injection of energy or power) into the electrical network 102. Each component of the electrical network 102 may be represented by any number of nodes in a network representation of the electrical network. Renewable energy sources 112 may include solar panels, wind turbines, and/or other forms of so called “green energy.” The electrical network 102 may include a wide electrical network grid (e.g., with 40,000 assets or more).

Each electrical asset of the electrical network 102 may represent one or more elements of their respective assets. For example, the transformer(s) 116, as shown in FIG. 1 may represent any number of transformers which make up electrical network 102.

In some embodiments, the renewable energy asset monitoring system 104 may be configured to receive sensor data from any number of sensors of any number of electrical assets, event data, and renewable energy asset production data. The renewable energy asset monitoring system 104 may subsequently use machine learning models trained to predict risk of failures of components and/or subcomponents of the renewable energy assets to generate or determine health indicators for the components and/or subcomponents of the renewable energy assets. The health indicators may be alerts for current or predicted problems that include a high severity risk alert, a medium severity risk alert, and a low severity risk alert. The renewable energy asset monitoring system 104 may then display the health indicators. In some embodiments, the renewable energy asset monitoring system 104 may send the health indicators to operations center(s) 120 for display by the operations center(s) 120.

While analysis and data associated with risk of failure is discussed herein, it will be appreciated that risk of failure may includes risks associated with degeneration of performance, risk of outright failure, and/or risk of damage (e.g., either to a component or risk to a related component/subcomponent). For example, if a generator shaft is unbalanced then there may be pressure on the generator bearings which may cause them to fail or and/or be damaged. In various embodiments, some systems and methods discussed herein may be utilized to assist with risk assessment to help replace or repair components and/or subcomponents before damage or failure (or to improve performance).

In some embodiments, communication network 108 represents one or more computer networks (e.g., LAN, WAN, and/or the like). Communication network 108 may provide communication between any of the renewable energy asset monitoring system 104, the power system 106, and/or the electrical network 102. In some implementations, communication network 108 comprises computer devices, routers, cables, uses, and/or other network topologies. In some embodiments, communication network 108 may be wired and/or wireless. In various embodiments, communication network 108 may comprise the Internet, one or more networks that may be public, private, IP-based, non-IP based, and so forth.

The renewable energy asset monitoring system 104 may include any number of digital devices configured to forecast component failure of any number of components and/or generators (e.g., wind turbine or solar power generator) of the renewable energy sources 112.

The power system 106 may include any number of digital devices configured to control distribution and/or transmission of energy. The power system 106 may, in one example, be controlled by a power company, utility, and/or the like. A digital device is any device with at least one processor and memory. Examples of systems, environments, and/or configurations that may be suitable for use with the system include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

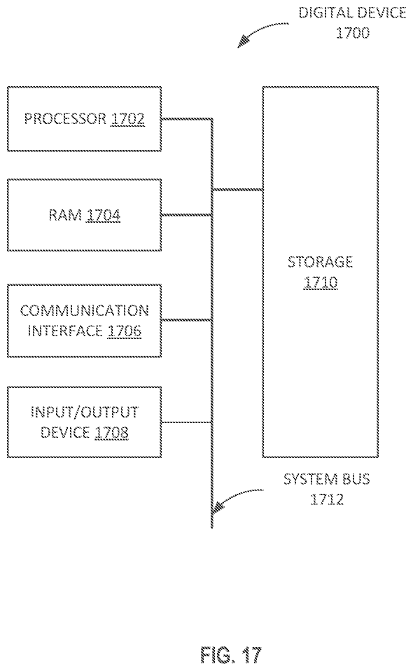

A computer system may be described in the general context of computer system executable instructions, such as program modules, being executed by a computer system. Generally, program modules may include routines, programs, objects, components, logic, data structures, and so on that perform particular tasks or implement particular abstract data types. A digital device, such as a computer system, is further described with regard to FIG. 17.

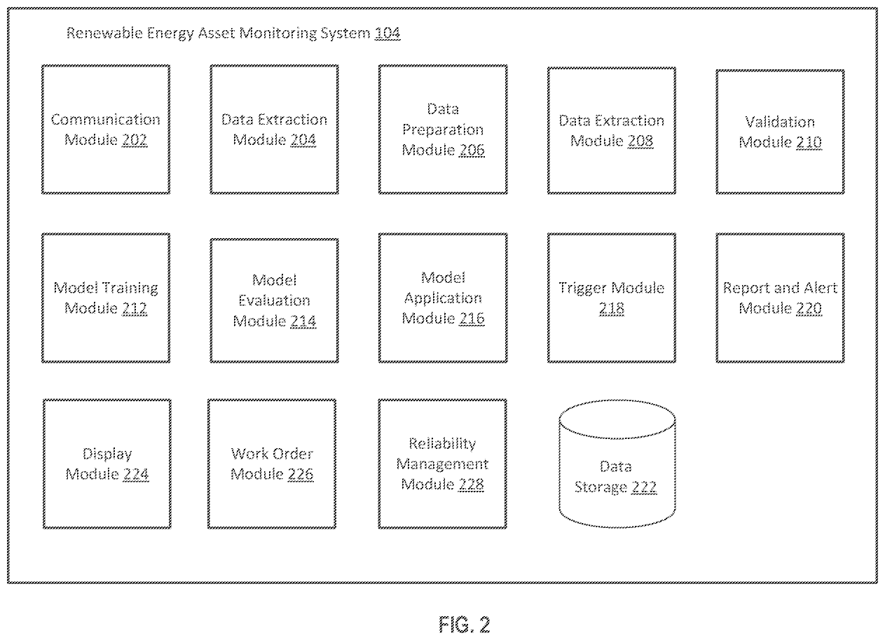

FIG. 2 is a block diagram of a renewable energy asset monitoring system 104 in some embodiments. The renewable energy asset monitoring system 104 may monitor multiple wind turbines on multiple wind turbine farms across multiple geographies, both on-shore and off-shore geographies. The renewable energy asset monitoring system 104 may predict a component or subcomponent failure ahead of the actual failure. The renewable energy asset monitoring system 104 may train and evaluate any number of models that predict component failure. In some embodiments, the renewable energy asset monitoring system 104 trains a set of component or subcomponent failure prediction models for any number of components or subcomponents or set of components or subcomponents using historical sensor data received from sensors of any number of electrical assets (e.g., including renewable energy electrical assets such as wind turbines) on sensor information (e.g., such as SCADA or other signals or data further discussed herein). In some embodiments, each set of models predicts risk of failure of a set of components or subcomponents of the same or different electrical assets.

The renewable energy asset monitoring system 104 may train different failure prediction models of a set using the same metrics from historical sensor data but with different lead times and with different amounts of historical sensor data (e.g., different amounts of lookback times). The renewable energy asset monitoring system 104 may evaluate the failure prediction models of the set based on sensitivity, precision, and/or specificity for the different lookback and lead times. As a result, the renewable energy asset monitoring system 104 may select a failure prediction model of a set of failure prediction models for each component or subcomponent type (e.g., bearing), component or subcomponent (e.g., specific bearing(s) in one or more assets), component or subcomponent group type (e.g., generator including two or more components or subcomponents), component or subcomponent group (e.g., specific generator(s) including two or more components or subcomponents in one or more assets), asset type (e.g., wind turbines), or group of assets (e.g., specific set of wind turbines). Each failure prediction model may assist in predicting risk of failure (or poor health) of one or more components and/or subcomponents.

Metrics used to evaluate performance (e.g., based on values from sensor readings and/or from the sensors themselves) may be the same for different components even if the sensor data from sensors of the different components is different. By standardizing metrics for evaluation, the renewable energy asset monitoring system 104 may “tune” or change aspects of the failure prediction model and model training to accomplish the goals of acceptable accuracy with acceptable lead time before the predicted failure. This enables improved accuracy for different components or subcomponents of an electrical assets with improved time of prediction (e.g., longer prediction times is preferable).

In some embodiments, the renewable energy asset monitoring system 104 may apply a multi-variate anomaly detection algorithm to sensors that are monitoring operating conditions of any number of renewable assets (e.g., wind turbines and or solar generators). The renewable energy asset monitoring system 104 may remove data associated with a past, actual failure of the system (e.g., of any number of components and or devices) or increased risk of failure, therefore highlighting subtle anomalies from normal operational conditions that lead to actual failures.

The renewable energy asset monitoring system 104 may fine-tune failure prediction models by applying dimensionality reduction techniques to remove noise from irrelevant sensor data (e.g., apply principal component analysis to generate a failure prediction model using linearly uncorrelated data and/or features from the data). For example, the renewable energy asset monitoring system 104 may utilize factor analysis to identify the importance of features within sensor data. The renewable energy asset monitoring system 104 may also utilize one or more weighting vectors to highlight a portion or subset of sensor data that has high impact on the failure.

In some embodiments, the renewable energy asset monitoring system 104 may further scope time series data of the sensor data by removing some sensor data from the actual failure time period. In various embodiments, the renewable energy asset monitoring system 104 may optionally utilize curated data features to improve the accuracy of detection. Gearbox failure risk detection, for example, may utilize temperature rise in the gearbox with regards to power generation, reactive power, and ambient temperature.

In some embodiments, the renewable energy asset monitoring system 104 may receive historical sensor data regarding renewable energy sources (e.g., wind turbines, solar panels, wind farms, solar farms, electrical grants, and/or the like). The renewable energy asset monitoring system 104 may break down the data in order to identify important features and remove noise of past failures or failure risk that may impact model building. The historical data may be curated to further identify important features and remove noise. The renewable energy asset monitoring system 104 may further identify labels or categories for machine learning. It will be appreciated that renewable energy asset monitoring system 104 may, in some embodiments, identify labels.

The renewable energy asset monitoring system 104 may receive sensor data regarding any number of components or subcomponents from any number of devices, such as wind turbines from a wind farm. The sensor data may include multivariate timeseries data which, when in combination with the labels or categories for machine learning, may assist for deep learning, latent variable mining, may provide insights for component risk failure indication. These insights, which may predict upcoming failures, may effectively enable responses to upcoming failures with sufficient lead time before failure impacts other components of energy generation.

It will be appreciated that identifying risk of potential upcoming failures for any number of components or subcomponents and renewable energy generation may become increasingly important as sources of energy migrate to renewable energy. Failure of one or more components or subcomponents may impact the grid significantly, and as a result may put the electrical grid, or the legacy components of the electrical grid, either under burden or cause them to fail completely. Further, failures of the electrical grid and/or failures of renewable energy sources may threaten loss of property, business, or life particularly at times where energy is critical (e.g., hospital systems, severe weather conditions such as heat waves, blizzards, or hurricanes, care for the sick, care for the elderly, and/or care of the young).

The renewable energy asset monitoring system 104 may comprise a communication module 202, a data extraction module 204, a data preparation module 206, a data extraction module 208, a validation module 210, a model training module 212, a model evaluation module 214, a model application module 216, a trigger module 218, a report and alert module 220, a display module 224, a work order module 226, a reliability management module 228, and a data storage 222. Examples discussed herein are with regard to wind turbines, but it will be appreciated that various systems and methods described herein may apply to any renewable energy asset (e.g., photovoltaic panels) or legacy electrical equipment. Additional functionality of modules may be described in U.S. patent application Ser. No. 16/235,361, entitled “SCALABLE SYSTEM AND METHOD FOR FORECASTING WIND TURBINE FAILURE WITH VARYING LEAD TIME WINDOWS”, filed Dec. 28, 2018, the entirety of which is incorporated by reference herein.

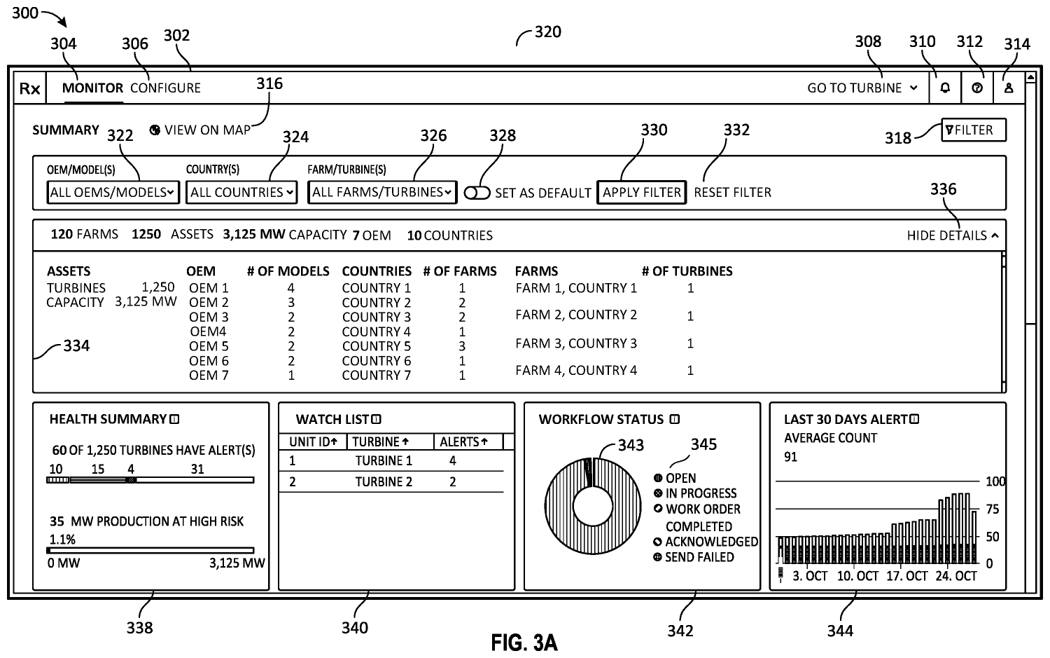

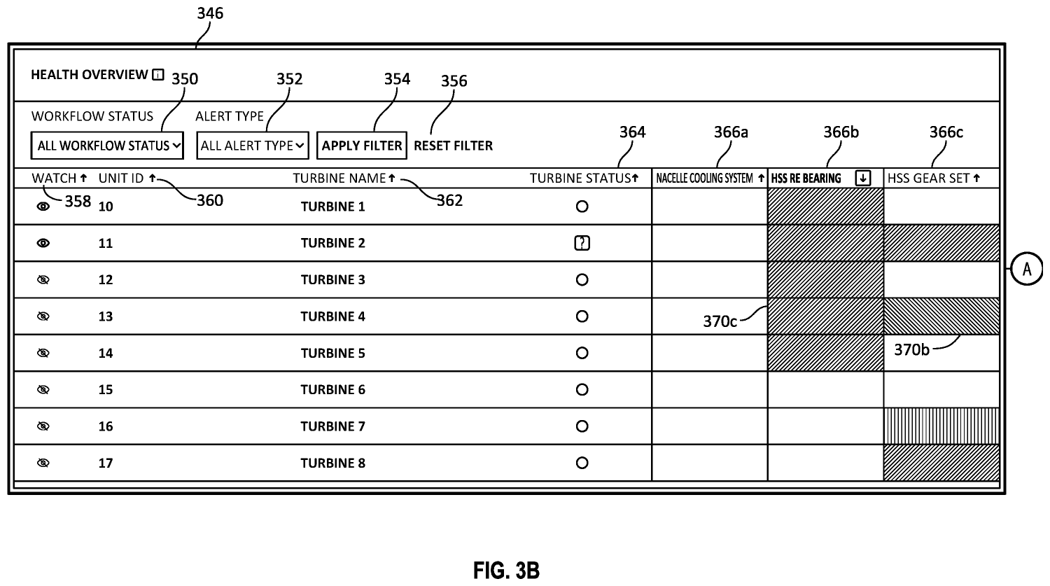

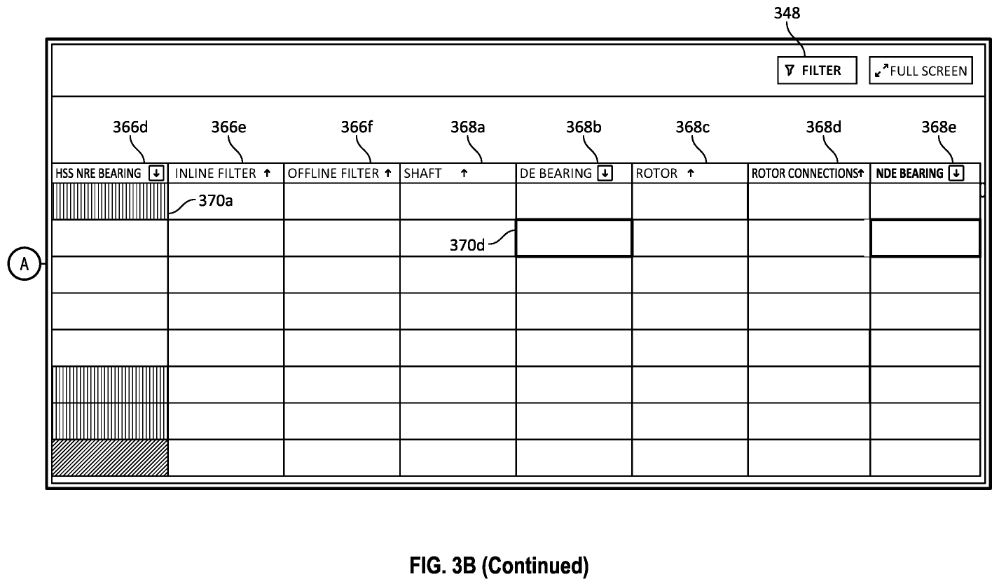

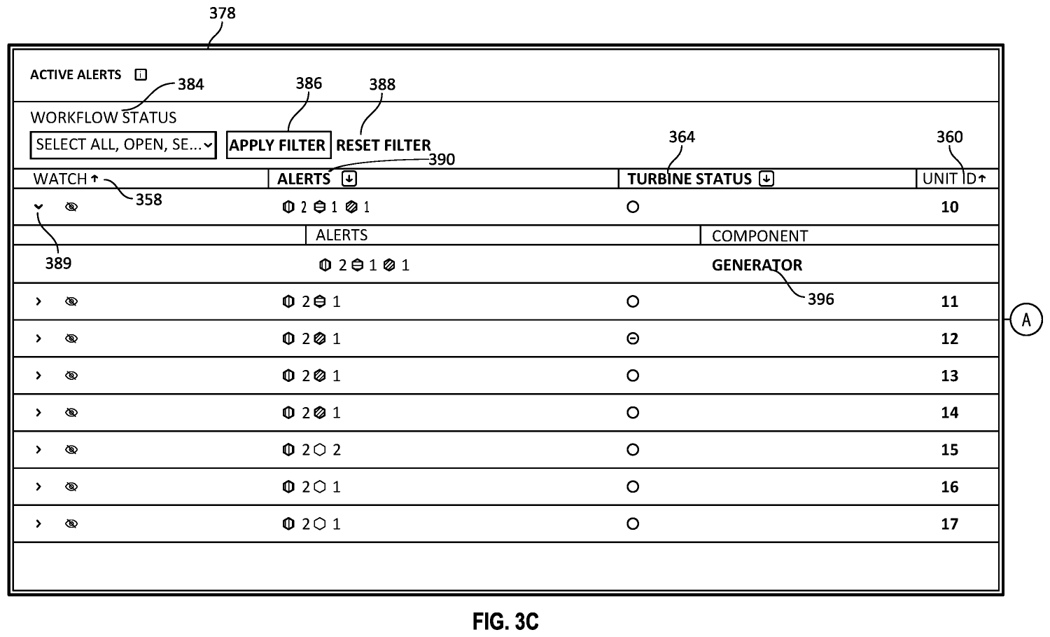

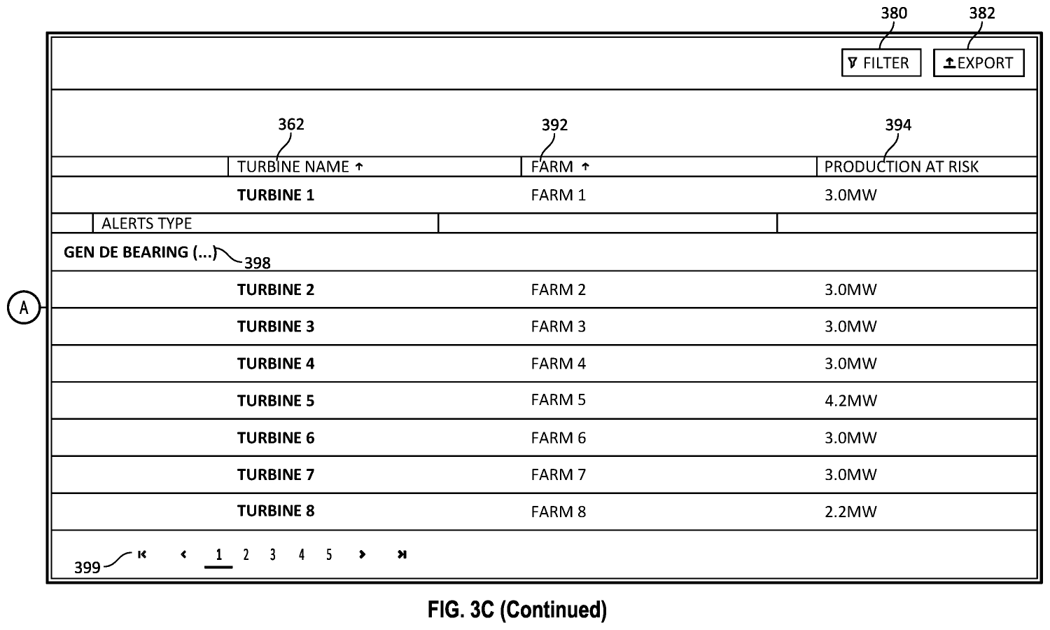

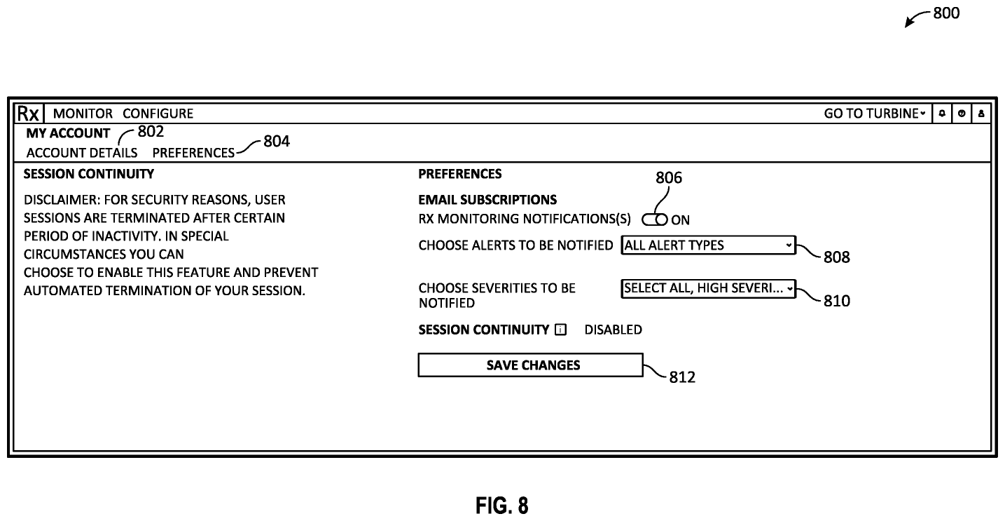

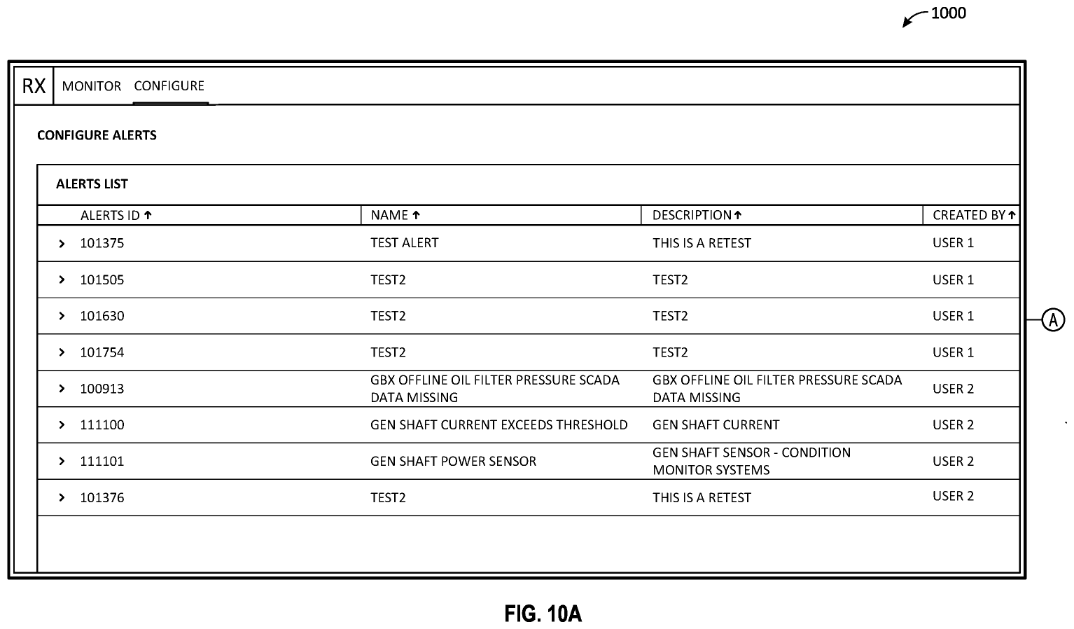

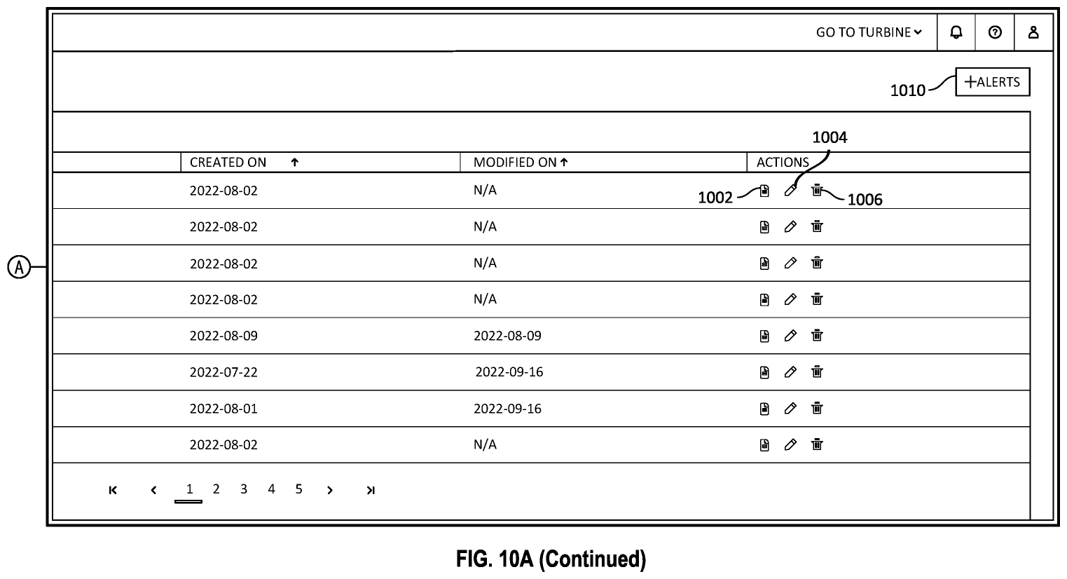

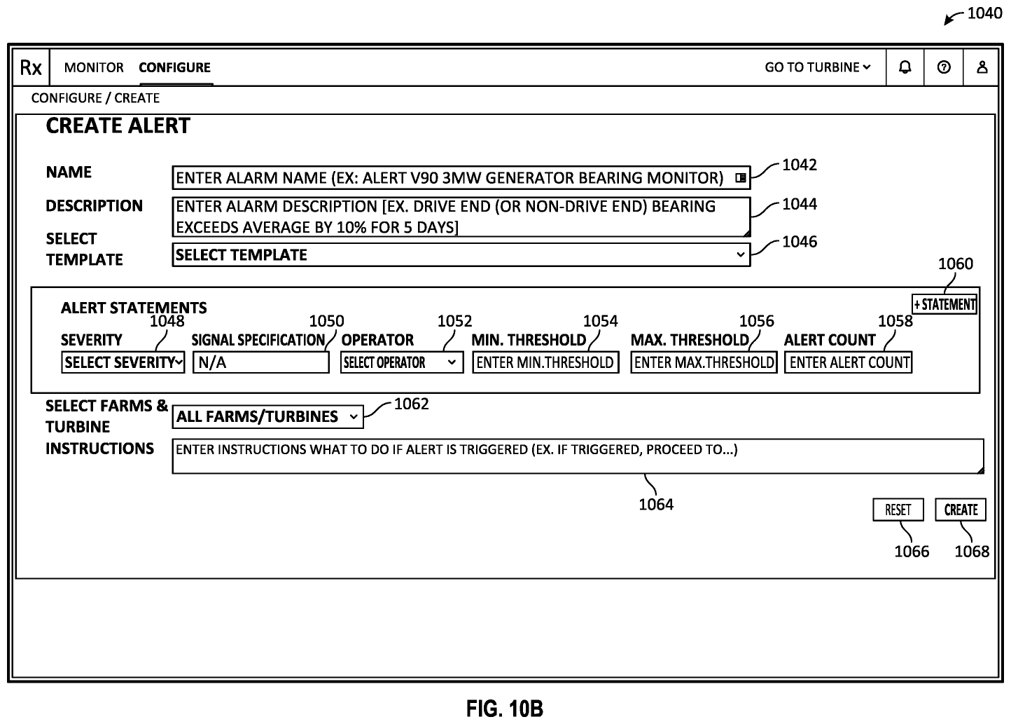

FIG. 3A depicts an example summary user interface 300 for the renewable energy asset monitoring system 104 in some embodiments. Modules discussed regarding FIG. 2 will also be discussed in the context of FIG. 3A. The display module 224 may be configured to generate the example summary user interface 300 and the other example user interfaces discussed in the context of FIGS. 3A-10. The display module 224 displays a header 302 located at the top of the summary user interface 300. The header 302 includes a Monitor tab 304, a Configure tab 306, a Go to Turbine selector 308, a notification icon 310, a help icon 312, and an account icon 314. The Monitor tab 304 may be the starting or default user interface of the renewable energy asset monitoring system 104. If a user of the renewable energy asset monitoring system 104 (hereinafter referred to as “the user”) selects the Configure tab 306, the display module 224 displays a configure alert user interface, which is discussed with reference to FIGS. 10A-B. If the user selects the Go to Turbine selector 308, the display module 224 displays a popup window (not shown in FIG. 3A) that has a list of farms and search input field. The user may select a farm from the list and then select a turbine in that farm. The user may also use the search input field to search for turbines. If the user selects the notification icon 310, the display module 224 displays a popup window (not shown in FIG. 3A) that has a list of notifications. If the user selects the help icon 312, the display module 224 displays a popup window (not shown in FIG. 3A) that has support contact information. If the user selects the account icon 314, the display module 224 displays a popup window (not shown in FIG. 3A) that has a hyperlink to the account user interface, which is discussed with reference to FIG. 8.

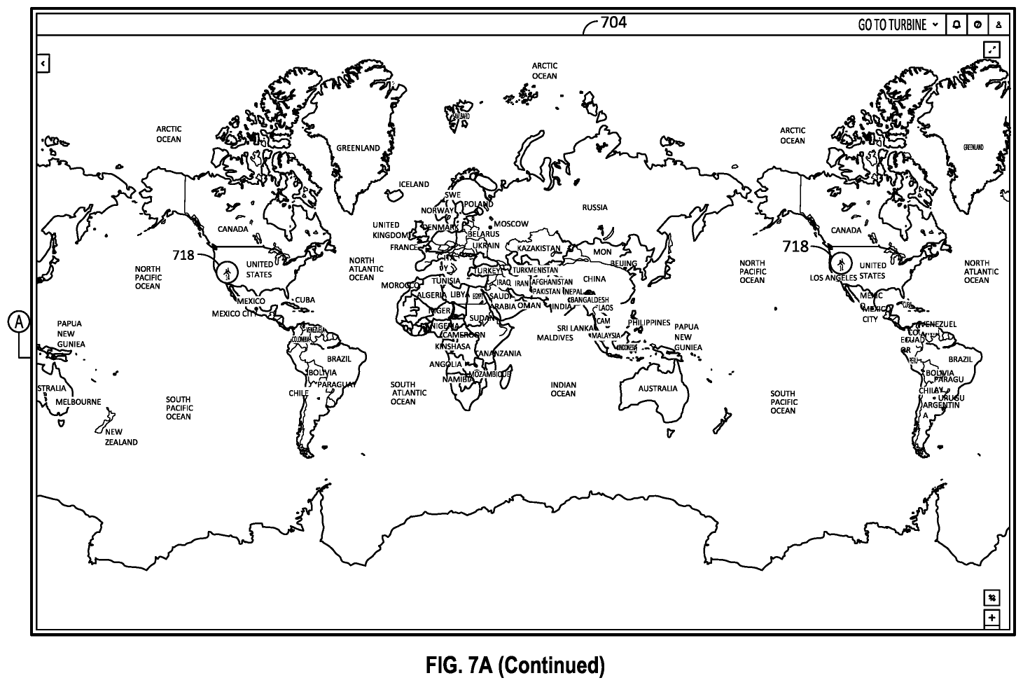

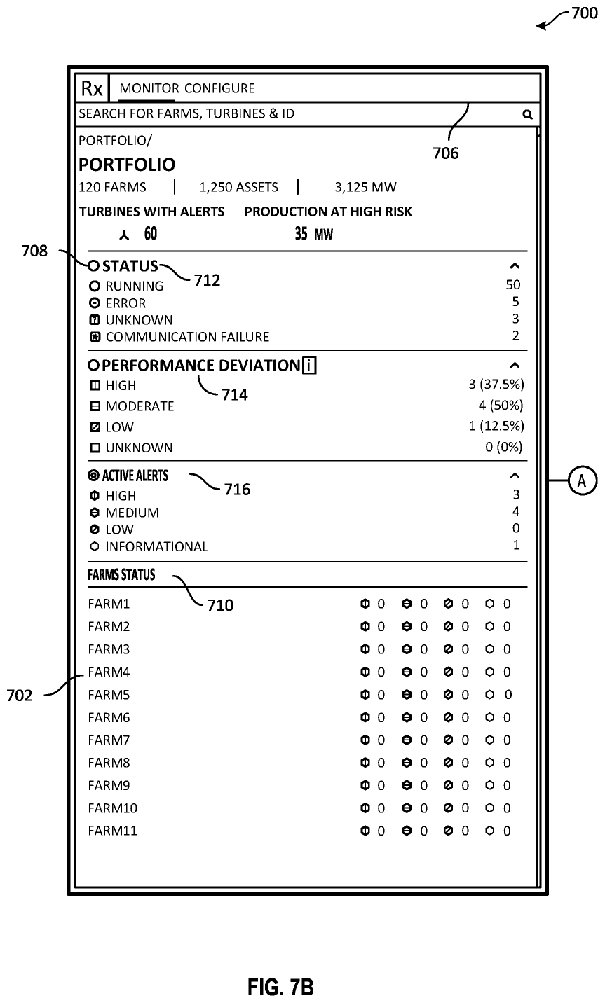

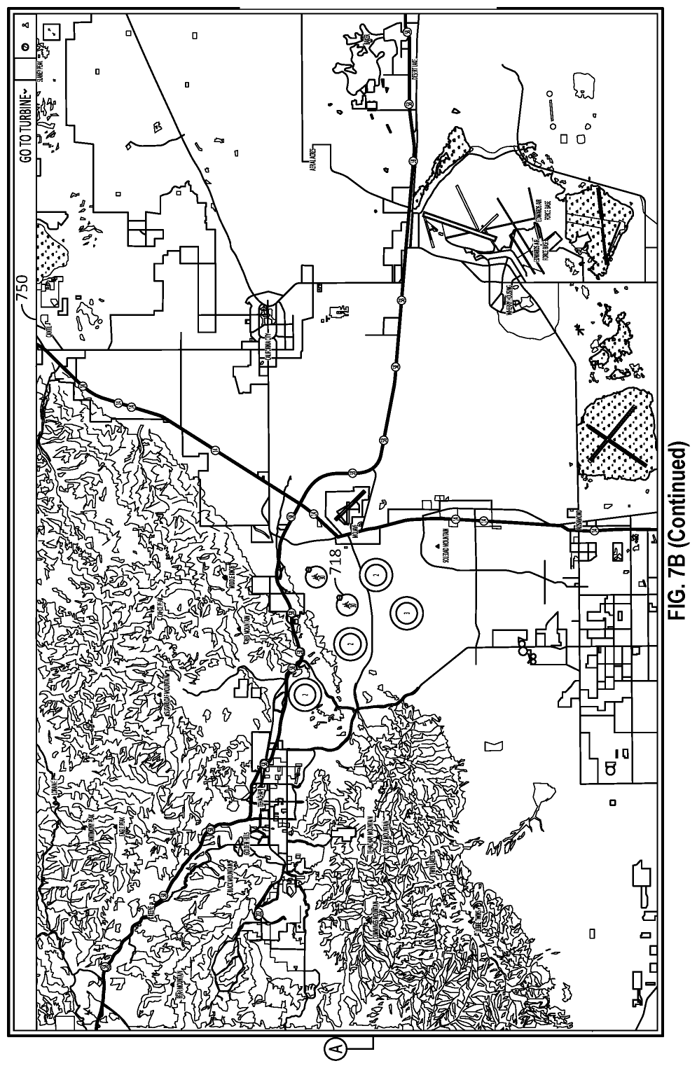

When the Monitor tab 304 is active, the summary user interface 300 has a Summary heading and a globe icon and View on Map link 316. If the user selects the globe icon and View on Map link 316, the display module 224 displays a map user interface, which is discussed with reference to FIGS. 7A and 7B. The summary user interface 300 also has a Filter button 318. If the user selects the Filter button 318, the display module 224 displays a Filter card 320. The Filter card 320 includes an OEM/Model(s) dropdown 322 that allows the user to select one or more turbine OEMs and/or turbine models, a Country dropdown 324 that allows the user to select one or more countries, and a Farm/Turbine(s) dropdown 326 that allows the user to select one or more farms and/or turbines in the farms. The user may apply a filter to include the selected OEMs and/or Models, Countries, and Farms and/or Turbines using the Apply Filter button 330. The user may reset the filter by selecting the Reset Filter link 332. The user may set a filter as the default view using the Set As Default toggle 328. If the user selects the Filter button 318 again the display module 224 causes the Filter card 320 to be hidden from view on the summary user interface 300.

The summary user interface 300 has additional cards including an Overview card 334, a Health Summary card 338, a Watch List card 340, a Workflow Status card 342, a Last 30 Days Alert card 344, a Health Overview card 346 (discussed with reference to FIG. 3B), and an Active Alerts card 378 (discussed with reference to FIG. 3C). The Overview card 334 lists the number of farms, the number of assets (turbines), total capacity in megawatts (MW), the number of original equipment manufacturers (OEMs) and the number of countries that the renewable energy asset monitoring system 104 monitors. The Overview card 334 also has information regarding the number of assets (the number of turbines and the total capacity in MW), a list of the OEMs and the number of models of each OEM, a list of the countries and the number of farms in each country, and a list of the farms and the number of turbines in each farm. The user may collapse the Overview card 334 by selecting a Hide Details link 336. One advantage of the Overview card 334 is that it provides high-level overview information on the turbines being monitored by the renewable energy asset monitoring system 104.

The Health Summary card 338 shows a health summary of the user's selected population of turbines, including how many turbines have alerts and the impact to production based on the turbines with high severity risk alerts. The Health Summary card 338 has a status bar indicating the number of turbines that have alerts (e.g., 60 of 1,250 turbines have alerts). In some embodiments, the alerts include a high severity risk alert that is shown in solid red (shown as vertical hashing in FIG. 3A), a medium severity risk alert that is shown in solid orange (shown as horizontal hashing in FIG. 3A), a low severity risk alert that is shown in solid yellow (shown as diagonal hashing in FIG. 3A), and an informational alert that is shown in solid gray (shown without hashing in FIG. 3A). The renewable energy asset monitoring system 104 may set the alert level for a turbine based on alert level(s) for one or more gearbox subcomponents and/or generator subcomponents of the turbine. How the renewable energy asset monitoring system 104 determines an alert level for a gearbox subcomponent and an alert level for a generator subcomponent is discussed with reference to the Health Overview card 346.

A person of ordinary skill in the art will understand that the display module 224 may use different colors and/or shapes to display alert information. The Health Summary card 334 also shows the amount of production (in MW) at high risk (e.g., 35 MW production at high risk) as well as the percentage of the overall total MW capacity (e.g., 1.1% at high risk of 3,125 MW capacity). One advantage of the Health Summary card 338 is that it displays visual indications of alert severity for the turbines that have alerts, as well as the amount and percentage of production at risk, thus giving the user a sense of the overall health of the turbines that the renewable energy asset monitoring system 104 monitors.

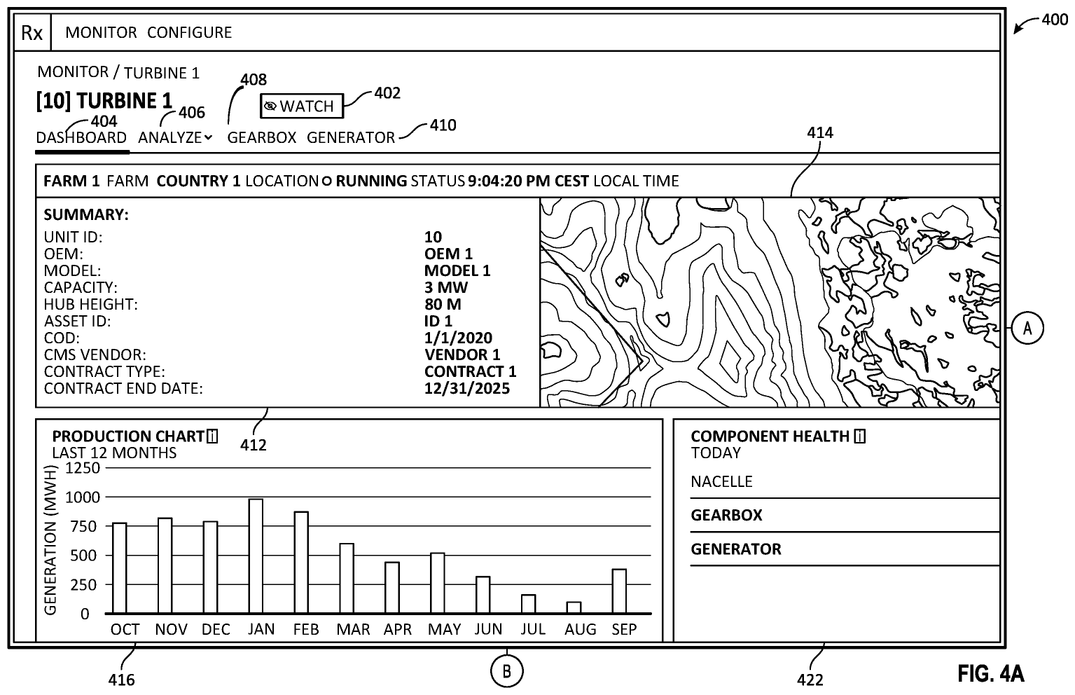

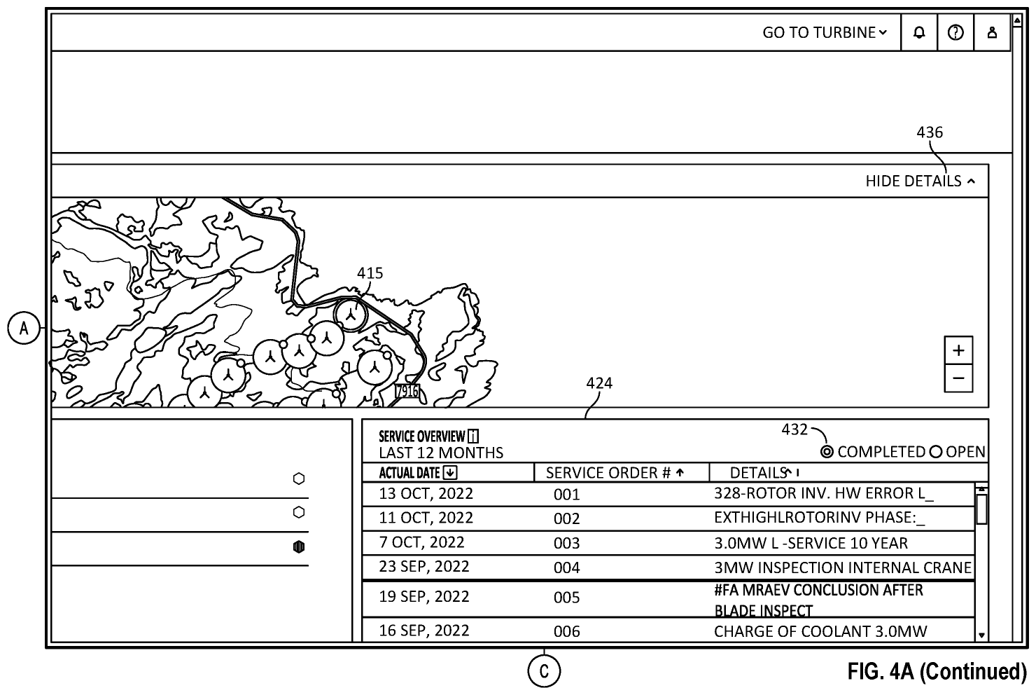

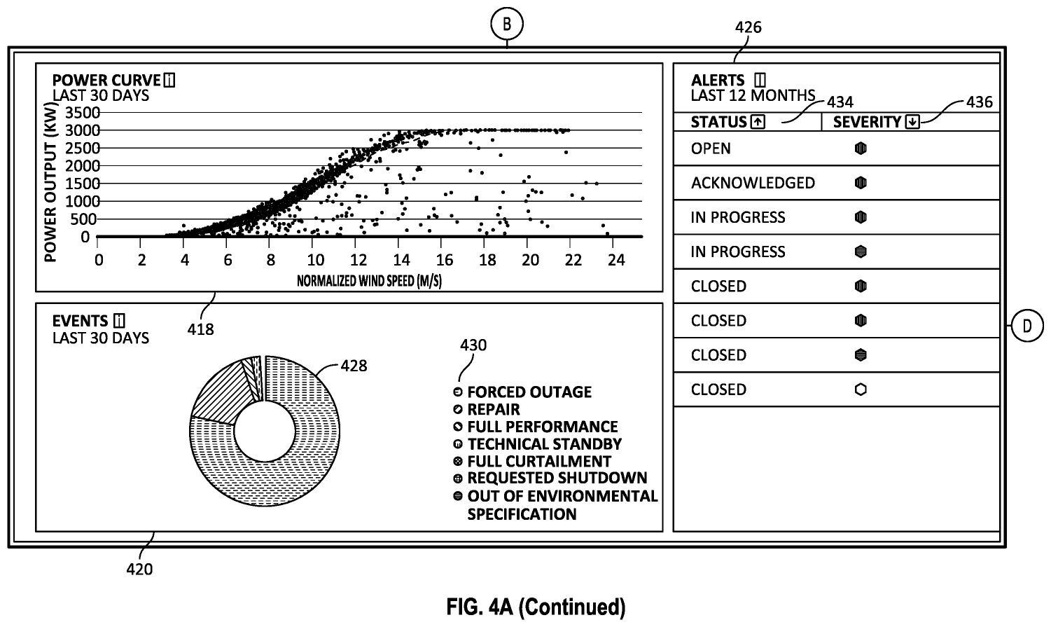

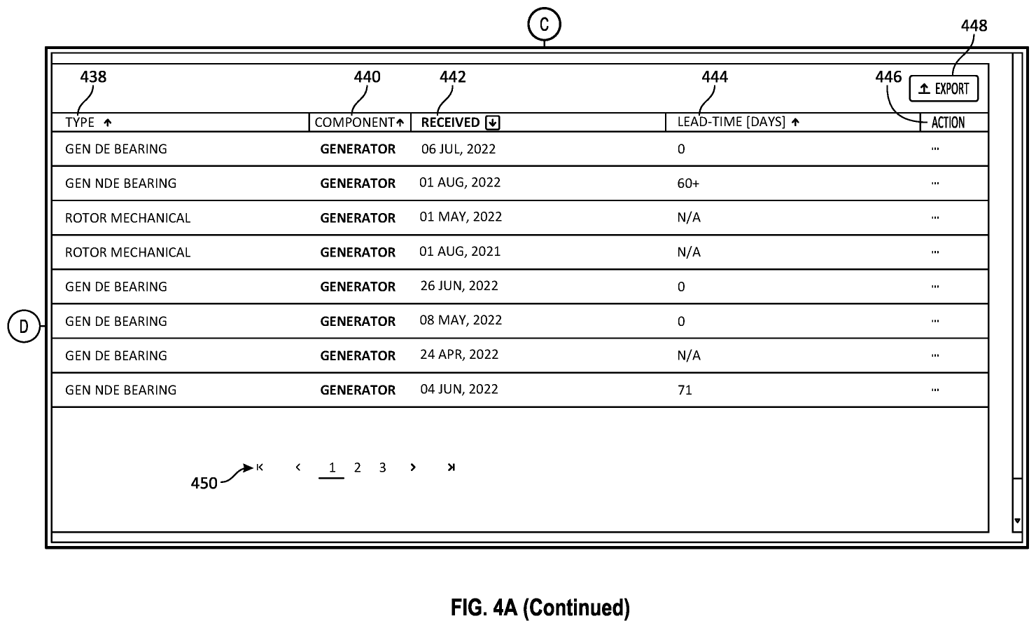

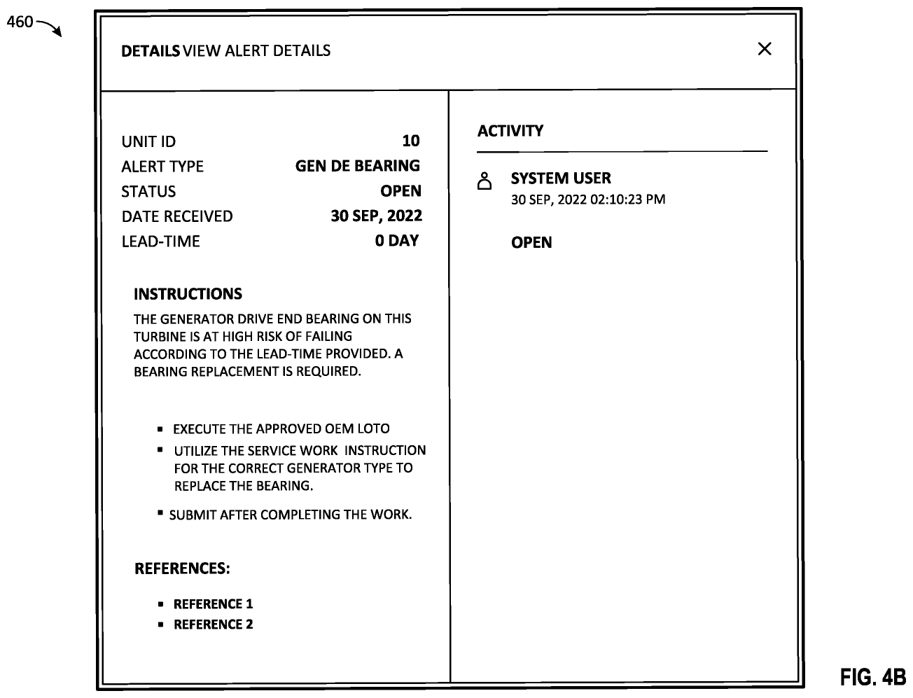

The Watch List card 340 shows a list of turbines that the user has selected to be watched. The watch list card displays a turbine unit ID, a turbine name, and a number of alerts for the turbine. As discussed with reference to the Health Overview card 346, the user may add and remove a turbine from the Watch List card 340. The turbine unit ID and the turbine name are hyperlinked to a turbine details user interface, which is discussed with reference to FIGS. 4A and 4B. An advantage of the Watch List card 340 is that it allows the user to keep track of turbines the user wants to look at frequently, e.g., every day, or that the user knows they'd like to see more information about.

The Workflow Status card 342 shows a graphical representation of high, medium and low severity active alerts, in the form of a doughnut chart 343, that the user may act on, by workflow status 345. The workflow statuses 345 may include Open, Send Initiated, Send Failed, Work Order Completed, Acknowledged (the work order module 226 may acknowledge an alert without sending it to a work order system), and In Progress. With regards to the Work Order Completed status, a work order may have a Work Order Completed status, but the condition prompting the work order has not normalized yet, and therefore the work order has not been closed out. The user may close an alert themselves before the condition has normalized, or the user may wait for the condition to normalize before closing out a work order. In some embodiments, the renewable energy asset monitoring system 104 may close the work order automatically once the condition normalizes. Work orders and their initiation are discussed further with reference to FIGS. 4A and 4B. The doughnut chart 343 displays workflow statuses portions with sizes corresponding to the number of their alerts in proportion to the total number of alerts. The user may hover over a portion of the doughnut chart 343 to see the number of alerts for the corresponding workflow status 345.

The user may toggle the inclusion of workflow statuses 345 in the doughnut chart 343 by selecting individual workflow statuses 345. Toggling off an individual workflow status 345 causes the display module 224 to display the individual workflow statuses 345 that are toggled on in the doughnut chart 343. For example, the user may toggle off individual workflow statuses 345 except for the Open workflow status. The doughnut chart 343 then displays alerts with a workflow status of Open. If the user selects a portion of the doughnut chart 343 corresponding to a particular workflow status, the display module 224 updates the doughnut chart to provide a graphical representation of the active alerts for that workflow status by generator or gearbox component. The doughnut chart 343 displays generator component and gearbox component portions with sizes corresponding to the number of their alerts in proportion to the total number of alerts for that workflow status. For example, the user may select the doughnut chart 343 portion corresponding to the Open workflow status. The doughnut chart 343 then displays a portion corresponding to the generator component and a portion corresponding to the gearbox component. The display module 224 sizes a portion in proportion to that component's part of the total number of alerts with an Open workflow status. Those of ordinary skill in the art will understand that different chart types may be used to graphically represent workflow statuses and components corresponding to active alerts. One advantage of the Workflow Status card 342 is that it allows the user to quickly see the proportion the number alerts for each individual workflow status 345 has to the total number of alerts.

The Last 30 Days Alert card 344 depicts a vertical stacked bar chart with the daily number of alerts over the past 30 days with sub-bars for alert severities (high severity, medium severity, low severity, and information). The user may hover over a vertical bar, which represents a single day, to see the number of alerts by severity for that particular day. The Last 30 Days Alert card 344 also displays the average number of alerts each day over the last 30 days. In some embodiments, periods of time other than days (e.g., weeks or months) are used to display the number of alerts for that time period. One advantage the Last 30 Days Alert card 344 provides is that it allows the user to quickly determine what the overall trend for daily alerts is by alert severity as well as the average number of daily alerts for the last 30 days.

FIG. 3B depicts the Health Overview card 346 of the summary user interface 300 for the renewable energy asset monitoring system 104 in some embodiments. The Health Overview card 346 has a list of turbines with the following columns: a watch 358 with eye icons that allow the user to add or remove a turbine to or from the Watch List card 340, a turbine unit ID 360, a turbine name 362, and a turbine status 364. The turbine unit ID 360 and turbine name 362 are hyperlinked to a turbine details user interface, which is discussed with reference to FIG. 4A. The turbine status 364 may include the following statuses: 1) running, which is visually indicated by an empty green circle (shown as an empty circle in FIG. 3B), 2) error, which is visually indicated by a solid red circle with a white horizontal dash (not shown in FIG. 3B), 3) unknown, which is visually indicated by a grey square with a question mark, and 4) communication failure, which is visually indicated by a grey square with an icon representing communication failure (not shown in FIG. 3B). The turbine list also has columns for displaying health indicators 370 for nacelle subcomponents 364, gearbox subcomponents 366 and generator subcomponents 368 that the renewable energy asset monitoring system 104 may monitor.

The Health Overview card 346 has a Filter button 348. If the user selects the Filter button 348 the display module 224 displays a Workflow Status dropdown 350, an Alert Type dropdown 352, an Apply Filter button 354, and a Reset Filter link 356. The user may select one or more workflow statuses of work orders for filtering using the Workflow Status dropdown 350. The workflow statuses may include Open, Send Initiated, Send Failed, Work Order Completed, Acknowledged, and In Progress. In some embodiments, the workflow statuses may include fewer or additional workflow statuses. The user may select one or more alert types for filtering using the Alert Type dropdown 352. The gearbox component alerts may include Gbx HSS RE Bearing, Gbx HSS Gear, Gbx HSS NRE Bearing, Gbx Inline Oil Filter Pres, and Gbx Offline Oil Filter Pres. The generator component alerts may include Shaft Misalignment, Gen DE Bearing, Gen DE Bearing Temp, Generator DE Bearing CMS Data Missing, LF Signal Data Missing Generator Bearing DE, Rotor Mechanical, Rotor Connections, High Frequency Missing Data Generator NDE ROTOR, Gen NDE Bearing, Gen NDE Bearing Temp, Gen NDE Bearing CMS Data Missing, and LF Signal Data Missing GenDE. The gearbox and generator alerts may include fewer or additional alerts. The Alert Type dropdown 352 may also include nacelle component alerts.

In another example, alerts may be generated associated with increased risk associated with degeneration of performance, risk of failure, and/or risk of damage, such as that associated with Generator Bearings (DE/NDE), Generator Overall Vibration Condition Monitor (DE/NDE), Generator Fan, Generator Slip Ring, Generator Rotor (Unbalance as example), Generator Shaft (Misalignment as an example), Gearbox HSS Bearings and Gears, Gearbox HSS Overall Vibration, Gearbox IMS Overall Vibration, Bearings, and Gears, Gearbox LSS Bearings and Gears, Gearbox Planetary—Bearings and Gears—all stages, Main Bearing as well, Tower (Cooling as example), and/or Nacelle (Cooling as example).

The user may select one or more workflow statuses using the Workflow Status dropdown 350 and/or one or more alert types using the Alert Type dropdown 352 and then apply a filter to include the selected one or more workflow statuses and/or the selected one or more alert types using the Apply Filter button 354. The display module 224 then updates the list of turbines to include those turbines matching the selected one or more workflow statuses and/or the selected one or more alert types. For example, the user may wish to see turbines that have work orders with a workflow status of Open or Acknowledged and that have an alert for the generator DE Bearing subcomponent or the generator NDE Bearing subcomponent. The user may select the Open and Acknowledged workflow statuses in the Workflow Status dropdown 350 and the Gen DE Bearing, Gen DE Bearing Temp, Generator DE Bearing CMS Data Missing, LF Signal Data Missing Generator Bearing DE alerts, Gen NDE Bearing, Gen NDE Bearing Temp, Gen NDE Bearing CMS Data Missing, and LF Signal Data Missing GenDE alerts in the Alert Type dropdown 352. The user then may select the Apply Filter button 354 to apply the filter. The display module 224 then displays those turbines that have work orders with a workflow status of Open or Acknowledged and that have an alert for the generator DE Bearing subcomponent or the generator NDE Bearing subcomponent. The user may then reset the filter by selecting the Reset Filter link 356. The display module 224 removes the applied filter and displays the monitored turbines in the list of turbines. If the user selects the Filter button 348 again the display module 224 hides the Workflow Status dropdown 350, the Alert Type dropdown 352, the Apply Filter button 354, and the Reset Filter link 356.

The report and alert module 220 may determine alert levels for gearbox subcomponents and generator subcomponents. As discussed herein, the model application module 216 may apply a machine learning model to generate a forecast for potential failure of a gearbox subcomponent or a generator subcomponent. The trigger module 218 may compare the forecast to a threshold to determine at which point in a varying lead time the forecast may exceed the threshold if it does exceed the threshold.

For example, a varying lead time may be from about less than or equal to 15 days to about less than or equal to 90 days for the generator DE Bearing subcomponent. The report and alert module 220 may then determine the alert severity risk level (e.g., high severity risk, medium severity risk, low severity risk, or informational) for the generator DE Bearing subcomponent based on the determination of the trigger module 218 (i.e., at which point in the varying lead time window the forecast may exceed the threshold, if it does exceed the threshold). The report and alert module 220 may determine a high severity risk alert if the generator DE Bearing subcomponent may exceed the threshold in about less than or equal to 15 days. The report and alert module 220 may determine a medium severity risk alert if the generator DE Bearing subcomponent may exceed the threshold in about less than or equal to 30 days. The report and alert module 220 may determine a low severity risk alert if the generator DE Bearing subcomponent may exceed the threshold in about less than or equal to 90 days.

In some embodiments, the varying lead time may be longer for offshore turbines than for onshore turbines. In some embodiments, the user may change the varying lead time from the system. In some embodiments, the varying lead time may be set for component type (e.g., bearing), component (e.g., specific bearing(s) in one or more assets), component group type (e.g., generator including two or more components), component group (e.g., specific generator(s) including two or more components in one or more assets), asset type (e.g., wind turbines), group of assets (e.g., specific set of wind turbines), system user (e.g., a user in an organization), or group of system users (e.g., multiple users in an organization).

In the turbine list, the monitored nacelle subcomponents may include a Nacelle Cooling System subcomponent 366a. The Nacelle Cooling System subcomponent 366a displays health indicators 370 for the nacelle cooling system alerts. In some embodiments, the monitored nacelle subcomponents may include additional nacelle subcomponents.

The monitored gearbox subcomponents 366 may include the following subcomponents: 1) an HSS (High-Speed Stage) RE Bearing subcomponent (also referred to as a first gearbox bearing subcomponent) 366b, an HSS Gear Set subcomponent (also referred to as a gear set subcomponent) 366c, an HSS NRE Bearing subcomponent (also referred to as a second gearbox bearing subcomponent) 366d, an Inline Filter subcomponent 366e, and an Offline Filter subcomponent 366f. The HSS RE Bearing subcomponent 366b displays health indicators 370 for alerts for the gearbox HSS RE Bearing subcomponent. The HSS Gear Set subcomponent 366c displays health indicators 370 for HSS Gear subcomponent alerts. The HSS NRE Bearing subcomponent 366d displays health indicators 370 for HSS NRE Bearing subcomponent alerts. The Inline Filter subcomponent 366e displays health indicators 370 for Gbx Inline Oil Filter Pres alerts. The Offline Filter subcomponent 366f displays health indicators 370 for Gbx Offline Oil Filter Pres alerts. In some embodiments, the monitored gearbox subcomponents 366 may include fewer or additional gearbox subcomponents. We have Gbx IMS, shaft misalignment, and others in progress

The monitored generator subcomponents 368 may include a Shaft subcomponent 368a, a DE (Drive-End) Bearing subcomponent (also referred to as a first generator bearing subcomponent) 368b, a Rotor subcomponent 368c, a Rotor Connections subcomponent 368d, and an NDE (Non-Drive-End) Bearing subcomponent (also referred to as a second generator bearing subcomponent) 368e. The Shaft subcomponent 368a displays health indicators 370 for Shaft Misalignment alerts. The DE Bearing subcomponent 368b displays health indicators 370 for Gen DE Bearing, Gen DE Bearing Temp, Generator DE Bearing CMS Data Missing, and LF Signal Data Missing Generator Bearing DE alerts. The Rotor subcomponent 368c displays health indicators 370 for Rotor Mechanical alerts. The Rotor Connections subcomponent 368d displays health indicators 370 for Rotor Connections and High Frequency Missing Data Generator NDE ROTOR alerts. The NDE Bearing subcomponent 368e displays health indicators 370 for Gen NDE Bearing, Gen NDE Bearing Temp, Gen NDE Bearing CMS Data Missing, and LF Signal Data Missing GenDE alerts. The monitored generator subcomponents 368 may include fewer or additional generator subcomponents in some embodiments.

The nacelle subcomponent column 366a, the gearbox subcomponents columns 366 and the generator subcomponents columns 368 display health indicators 370 for the monitored nacelle subcomponents, gearbox subcomponents and generator subcomponents for which there are active alerts. The display module 224 may determine a health indicator for a monitored subcomponent based on the highest (or generally highest) severity active alert for the subcomponent. For example, a DE Bearing subcomponent 368b may have a high severity active alert, a medium severity active alert, and an informational alert. The display module 224 would display a health indicator corresponding to a high severity active alert for the DE Bearing subcomponent 368b. As another example, an HSS RE Bearing subcomponent 366b may have a medium severity active alert and a low severity active alert. The display module 224 would display a health indicator corresponding to a medium severity active alert for the HSS RE Bearing subcomponent 366b.

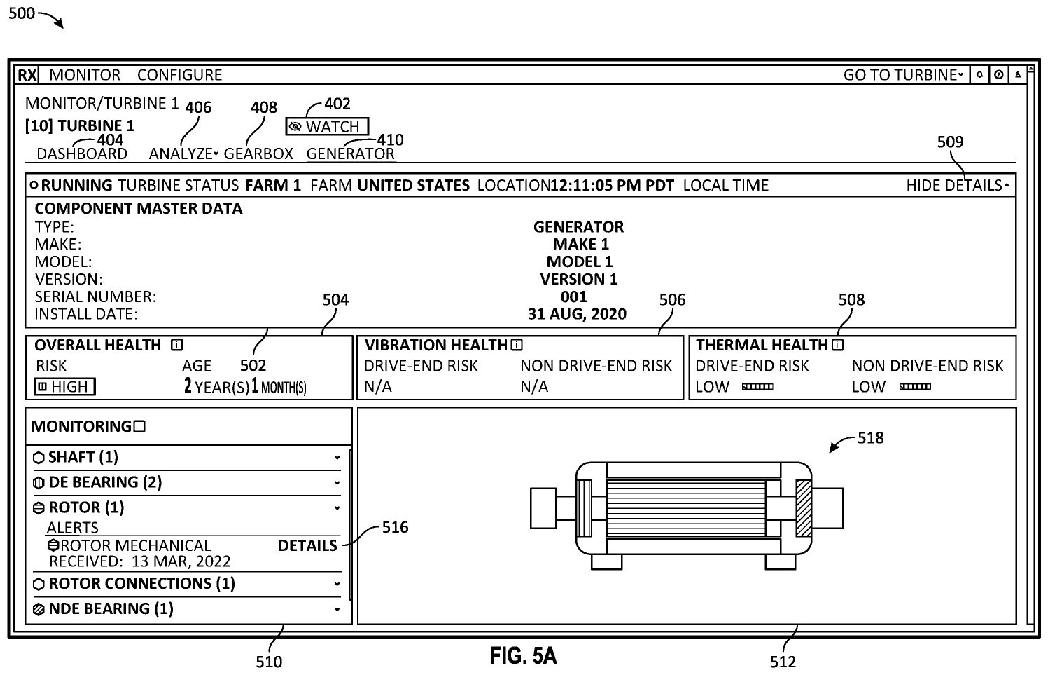

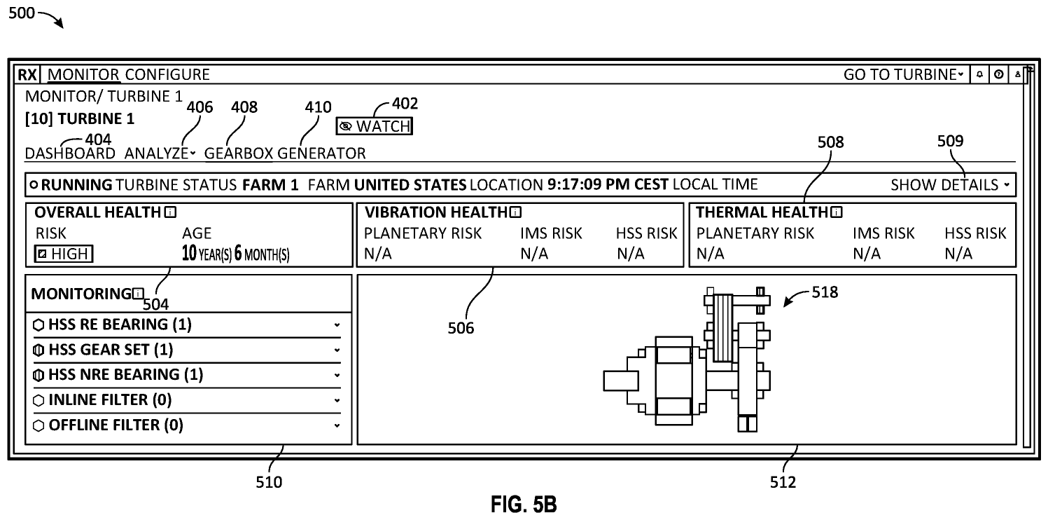

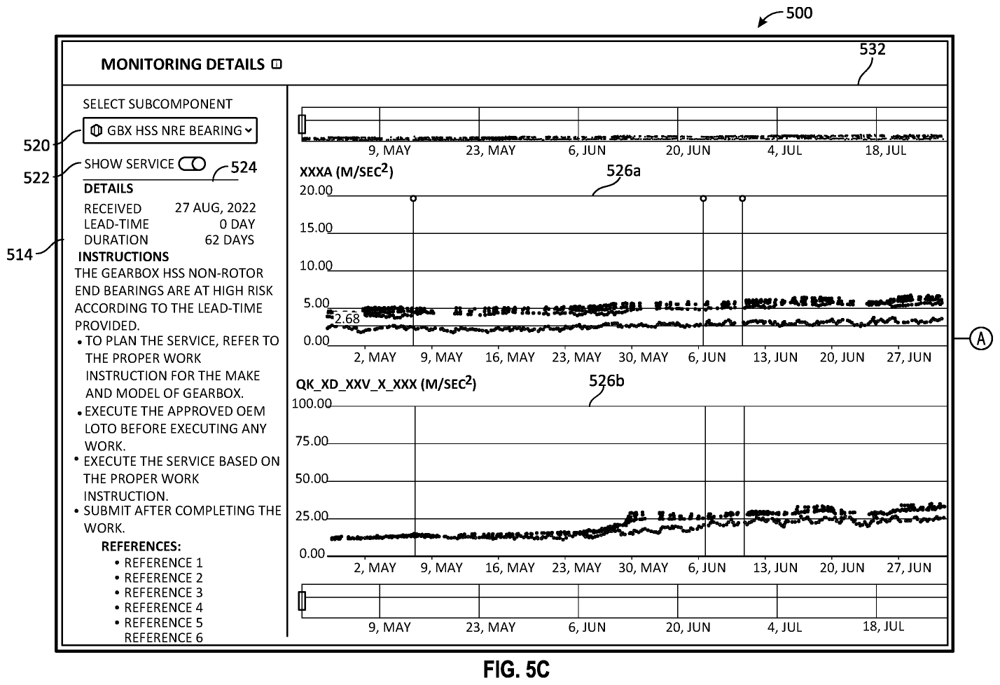

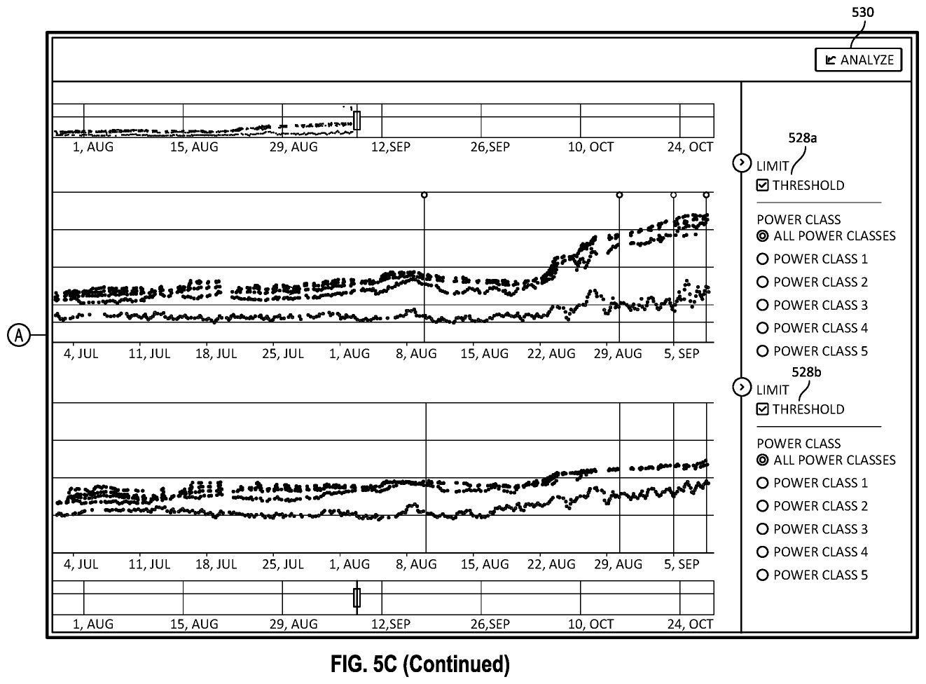

The display module 224 may display health indicators 370 according to the following: 1) a high severity health indicator as a solid red rectangle 370a (shown as a rectangle with vertical hashing in FIG. 3B) when the highest (or generally highest) severity level for active alerts for the monitored subcomponent is high, 2) a medium severity health indicator as an orange rectangle 370b (shown as a rectangle with horizontal hashing in FIG. 3B) when the highest (or generally highest) severity level for active alerts for the monitored subcomponent is medium, 3) a low severity health indicator as a yellow rectangle 370c (shown as a rectangle with diagonal hashing in FIG. 3B) when the highest (or generally highest) severity level for active alerts for the monitored subcomponent is low, and 4) an informational health indicator as a gray rectangle 370d (shown as a rectangle with a thicker border in FIG. 3B) when the active alert is informational. The user may hover over a health indicator 370 to see information about the active alert(s). The display module 224 then displays a popup containing information about the alert(s), such as the turbine name, hexagon icon(s) with the color or border corresponding to the alert severity level, and the date(s) of the alert(s). The display module 224 hyperlinks the health indicators 370 to a turbine component details user interface, which is discussed with reference to FIGS. 5A and 5B.

Each of the columns 358-366 in the turbine list is sortable. The user may turn on sorting by selecting the arrow to the right of the column header. The user may sort a column ascending or descending, and the user may turn off sorting for the column. The user determines the column sort order by the order in which the user turns on sorting for columns. For example, the user may turn on sorting for the HSS RE Bearing subcomponent 366b, then the HSS NRE bearing subcomponent 366d, then the DE Bearing subcomponent 368b, and then the NDE bearing subcomponent 368e. The display module 224 sorts the turbine list by the HSS RE Bearing subcomponent 366b first, the HSS NRE bearing subcomponent 366d second, the DE Bearing subcomponent 368b third, and the NDE bearing subcomponent 368e fourth. The display module 224 sorts the nacelle subcomponent column 366a, the gearbox subcomponents columns 366 and the generator subcomponents columns 368 in descending order from high severity health indicator to medium severity health indicator to low severity health indicator to informational health indicator to no active alerts. The display module 224 sorts the nacelle subcomponent column 366a, the gearbox subcomponents columns 366 and the generator subcomponents columns 368 in the reverse (i.e., from informational to high) for ascending order.

One advantage of the Health Overview card 346 is that it provides a view of the health indicators 370 of multiple generator subcomponents and gearbox subcomponents of multiple turbines. The user may thus easily see the predicted health of such subcomponents without having to access multiple systems or visiting the assets personally. Another advantage is that the combination of turbine status data and the health indicators 370 enables the user to make population-wide treatment decisions using a single view. Another advantage is that the sorting and filtering functionality of the Health Overview card 346 allows the user to customize what data the user wishes to see, which allows the user to focus on specific problems.

FIG. 3C depicts an Active Alerts card 378 of the summary user interface 300 for the renewable energy asset monitoring system 104 in some embodiments. The display module 224 may display the Active Alerts card 378, which shows a list of turbines with active alerts with the following columns: the watch 358, an alerts 390 that displays information about active alerts, the turbine status 364, the turbine unit ID 360, the turbine name 362, a turbine farm 392 that displays the name of the farm the turbine is in, and a production at risk 394 that displays the production at risk in MW of the turbine. The display module 224 hyperlinks the turbine unit ID 360 and the turbine name 362 to a turbine details user interface, which is discussed with reference to FIG. 4A. Each row of the turbine list has an arrow 398. The user may use the arrow 398 to expand the row. The display module 224 then shows more information about the active alerts, including the component 396 (e.g., nacelle, generator, or gearbox) and the alerts type 398. The component 396 may be hyperlinked to a turbine component details user interface, which is discussed with reference to FIGS. 5A and 5B. The alerts type 398 shows a single active alert and includes an ellipse in parentheses. The user may hover over the ellipse to see the other active alerts, if any. The Active Alerts card also has a page selector 399 that allows the user to access different pages of turbines with alerts.

The Active Alerts card 378 has a Filter button 380. If the user selects the Filter button 380, the display module 224 then displays a Workflow Status dropdown 384, an Apply Filter button 386, and a Reset Filter link 388. The Workflow Status dropdown 384 allows the user to select one or more workflow statuses of work orders for filtering. The workflow statuses may include Open, Send Initiated, Send Failed, Work Order Completed, Acknowledged, and In Progress. The workflow statuses may include fewer or additional workflow statuses. As a default all the workflow statuses may be selected, and the user may deselect workflow statuses. The user may select one or more workflow statuses using the Workflow Status dropdown and then select the Apply Filter button 386. The display module 224 then updates the turbine list to include those turbines matching the selected one or more workflow statuses. If the user selects the Filter button 380 again the display module 224 hides the Workflow Status dropdown 384, the Apply Filter button 386, and the Reset Filter link 388. The Active Alerts card 378 also has an Export button 382. If the user selects the Export button 382 the display module 224 exports the turbine list in a comma-separated values file that the user may download.

Like the columns in the turbine list in the Health Overview card 346, each of the columns 358-362 and 390-394 in the turbine list in the Active Alerts card 378 is sortable. The user may turn on sorting by selecting the arrow to the right of the column header. The user may sort a column ascending or descending, and the user may turn off sorting for the column. The user determines the column sort order by the order in which the user turns on sorting for columns. For example, the user may sort by alerts 390 in descending order first and turbine status 364 in descending order second. The display module 224 then sorts the turbine list by the alerts in descending order first and turbine status 364 in descending order second.

One advantage of the Active Alerts card 378 is that it allows the user to see a list of turbines with alerts organized by the number and severity of alerts for that turbine. Another advantage is that the user may filter on workflow status so as to quickly and easily see turbines with alerts, and for each turbine, the number and severity of the alerts, the turbine status, the farm the turbine is located in, and the production at risk. Furthermore, the user may sort any of the columns in the turbine list.

FIG. 4A depicts a turbine details user interface 400 for a renewable energy asset monitoring system 104 in some embodiments. The display module 224 displays the turbine details user interface 400 if the user selects the hyperlinked turbine unit ID or turbine name in the Watch List card 340, the Health Overview Card 346 or the Active Alerts card 378 in the summary user interface 300. The turbine details user interface 400 includes four tabs: a Dashboard tab 404, an Analyze tab 406, a Gearbox tab 408, and a Generator tab 410. The dashboard tab 480 has multiple cards including an Overview card 412, a Production Chart card 416, a Power Curve card 418, an Events card 420, a Component Health card 422, a Service Overview card 424, and an Alerts card 426.

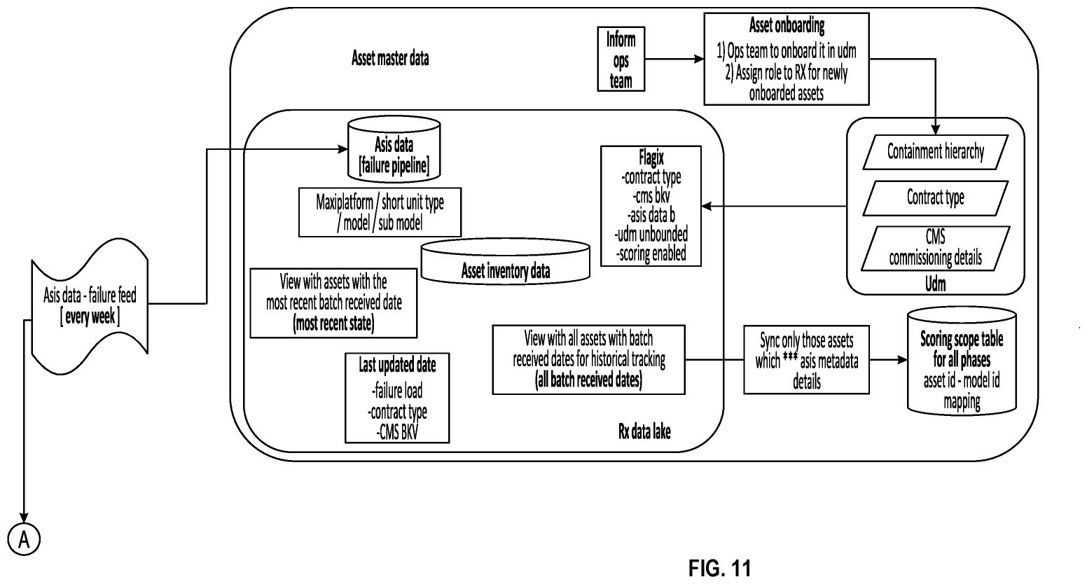

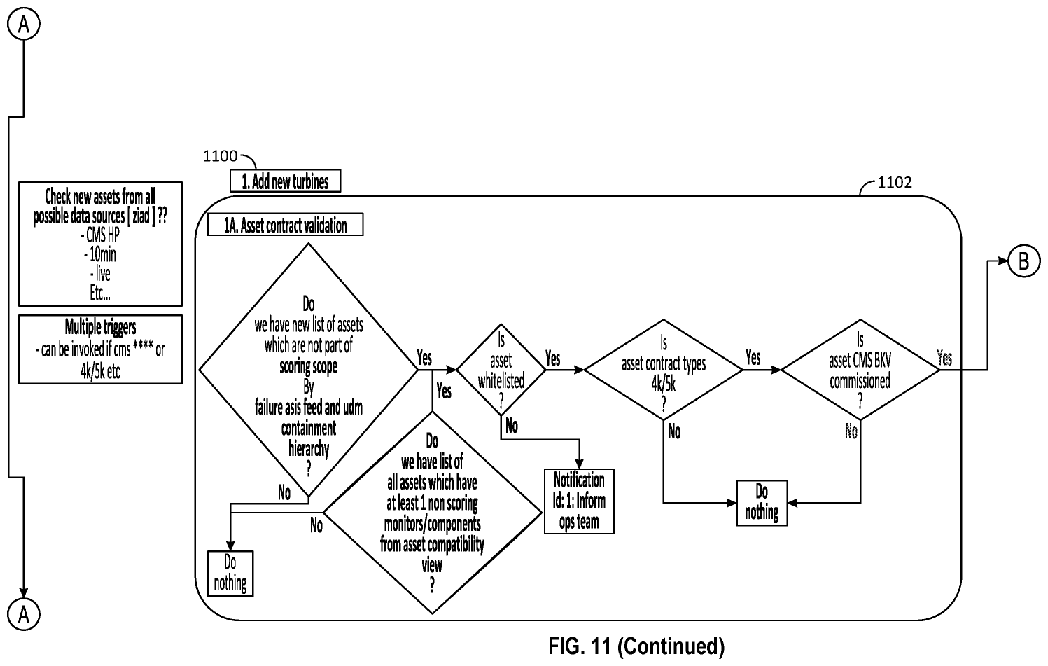

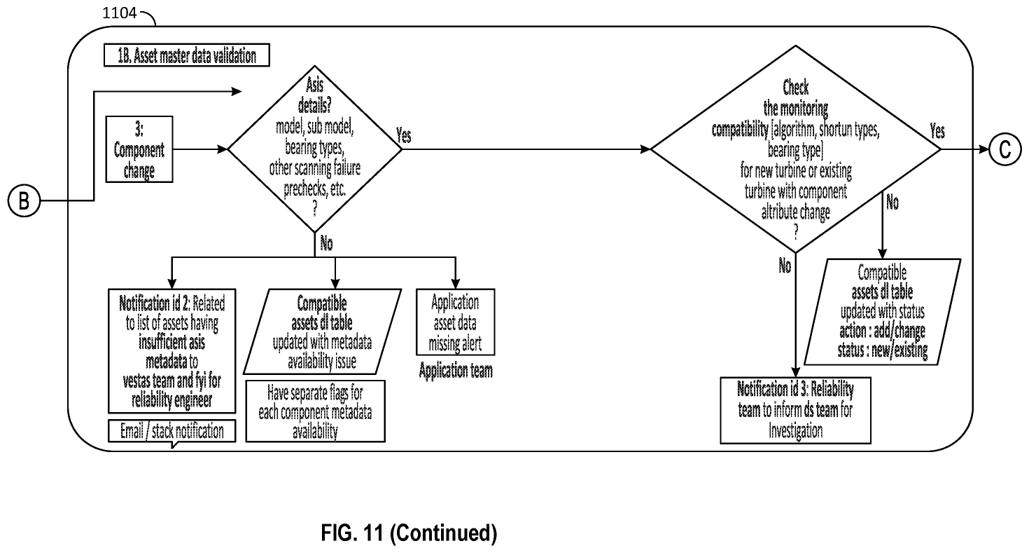

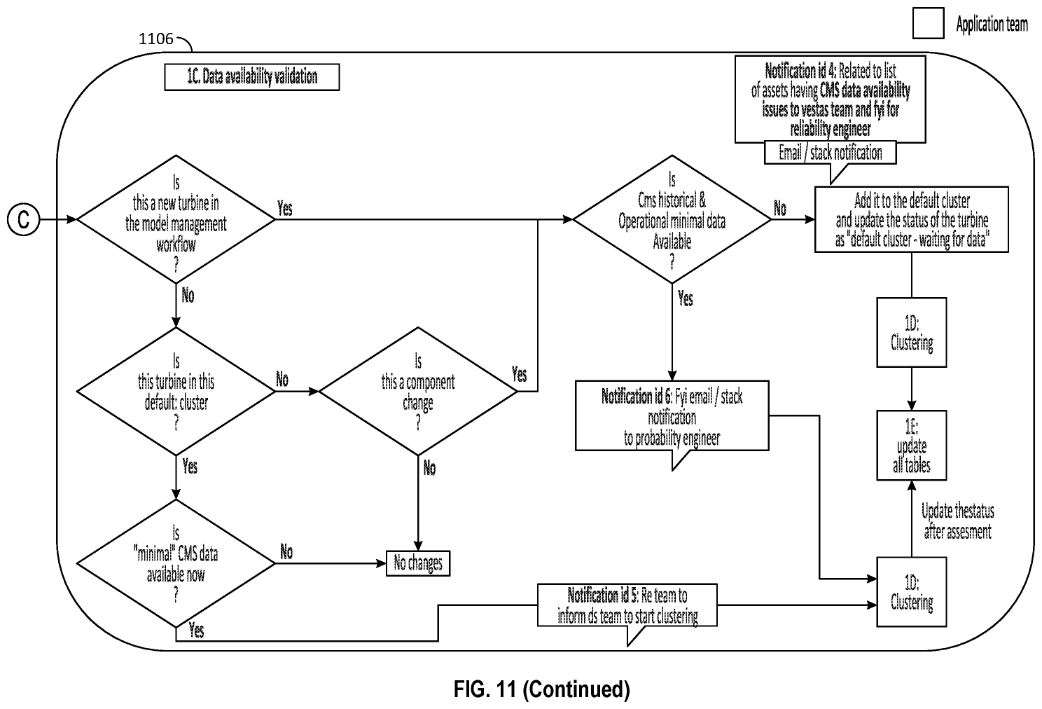

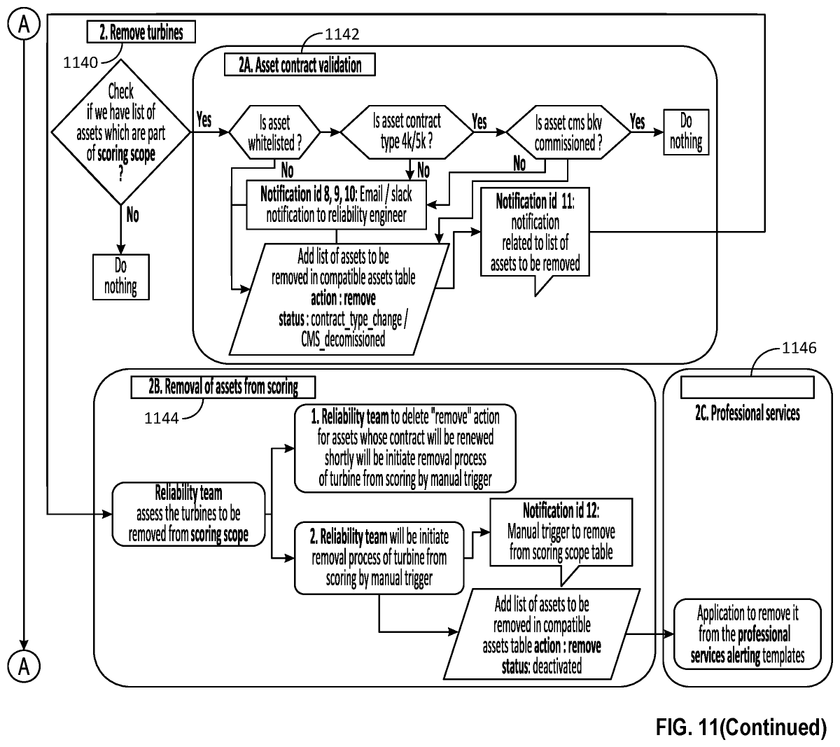

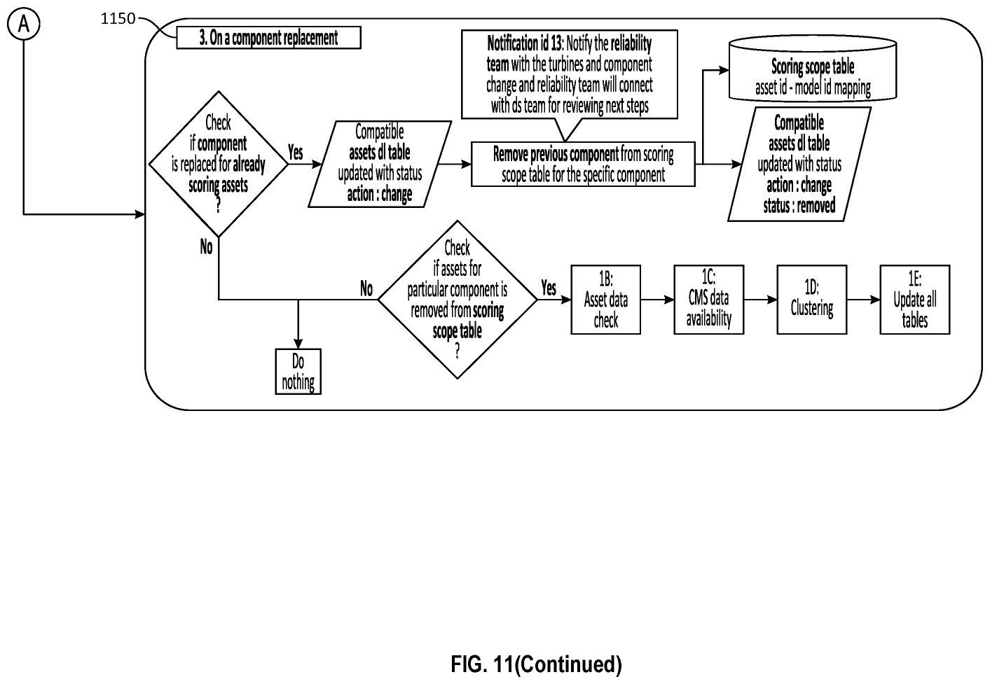

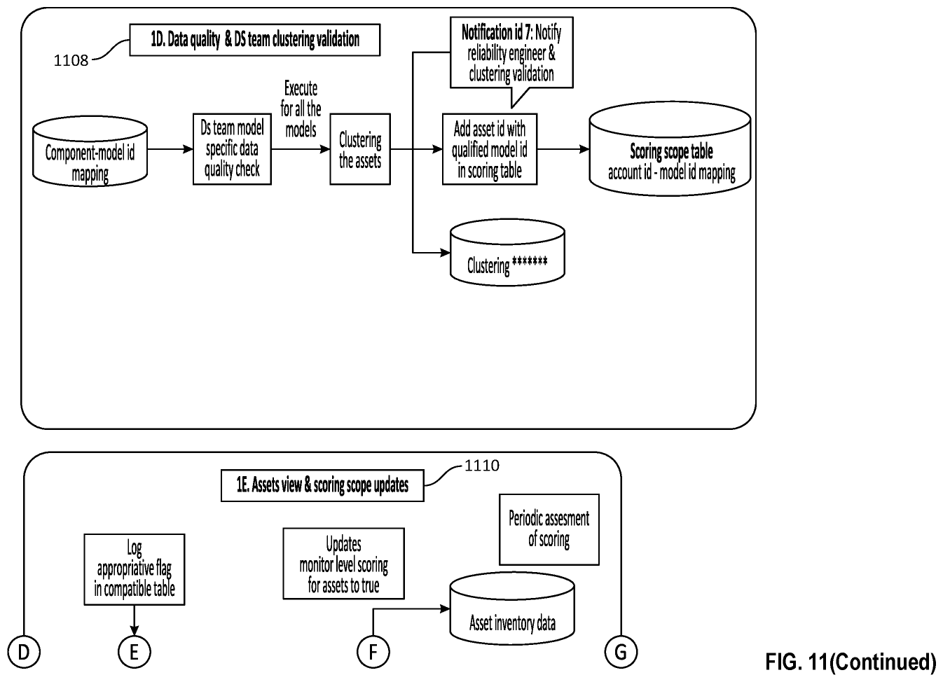

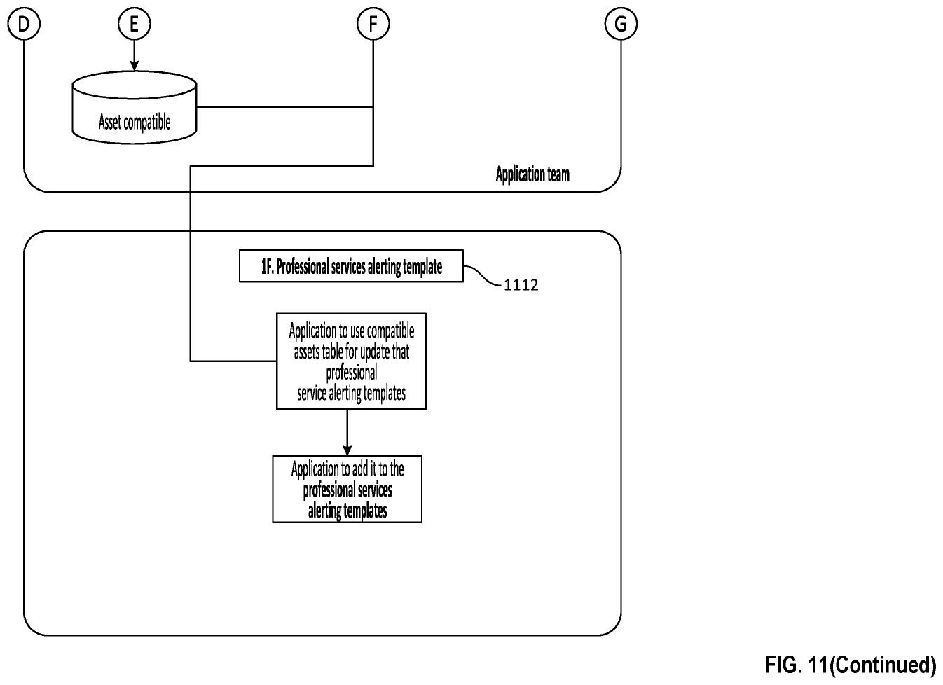

The Overview card 412 lists the name of the farm, the geography, the status, and the local time of the turbine. The Overview card 412 also shows summary information about the turbine including the unit ID, the Original Equipment Manufacturer (OEM), the model, the capacity in MW, the hub height, the asset ID, the COD date, the CMS Vendor, the contract type, and the contract end date. In some embodiments, the reliability management module 228 may obtain certain summary information using a background reliability management process, which is discussed with reference to FIG. 11. The Overview card 412 also has a zoomable and scrollable map region 414 with the location of the turbine shown as a circular icon 415. The user may collapse the Overview card 412 by selecting a Hide Details link 436. One advantage of the Overview card 412 is that it provides high-level overview information on the turbine.

The Production Chart card 416 shows the last 12 months of production for the turbine, with generation (in MWh) the vertical axis and time (in months) the horizontal axis. In some embodiments, the display module 224 uses periods of time other than months (e.g., days, weeks or years) to display generation. One advantage of the Production Chart card 416 is that it allows the user to see how the turbine production has varied by month over the last 12 months. The Power Curve card 418 shows the turbine's binned performance curve (dashed line) with real-time data (dots) from the previous 30 days. The horizontal axis is normalized wind speed in meters per second (m/s) and the vertical axis is power output in kilowatt-hours (kWh). The user may hover over a dot or the dashed line to see the wind speed and power output. The Power Curve card 418 depicts a power curve for a 3 MW turbine. One advantage of the Power Curve card 418 is that it allows the user to see the performance curve and real-time performance data of the turbine which may be related to the health of the asset.

The Events card 420 shows a graphical representation of events, in the form of a doughnut chart 428, that the user may act on, by event 430. The events may include Forced Outage, Repair, Full Performance, Technical Standby, Full Curtailment, Requested Shutdown, and Out of Environmental Specification. The doughnut chart 428 has event portions with sizes corresponding to the amount of their loss (in MWh) in proportion to the total amount of loss. The user may hover over a portion of the doughnut chart 428 to see the amount of loss for the corresponding event 430. The user may toggle the inclusion of events 430 in the doughnut chart 428 by selecting individual events 430. If the user toggles off an individual event 430, the display module 224 displays the individual events 430 that are toggled on in the doughnut chart 428. For example, the user may toggle off individual events 430 except for the Repair event. The doughnut chart 428 would then display loss for the Repair event. Selecting a portion of the doughnut chart corresponding to an event causes the display module 224 to update the doughnut chart 428 to provide a graphical representation of the duration of that event in minutes. The user may hover over the doughnut chart 428 to see the graphical representation of the duration. For example, the user may select the doughnut chart 428 portion corresponding to the Forced Outage event. The doughnut chart 428 then displays the total duration of the Forced Outage event in minutes. Those of ordinary skill in the art will understand that different chart types may be used to graphically represent workflow statuses and components corresponding to active alerts. One advantage of the Events card 420 is that it allows the user to quickly see the proportion of the loss for each individual event 430 as to the total amount of loss and how it may relate to the health of the asset.

The Component Health card 422 shows a list of components of the turbine and a graphical indication of the current risk level (low, medium, high, not monitored) of each component. The components may include the nacelle, gearbox, and generator components, as well as any other turbine components. The gearbox and generator components are hyperlinked to a turbine component details user interface 500 described with reference to FIGS. 5A-C. In some embodiments, the Component Health card 422 shows a low severity health indicator as an empty hexagon with a green border (not shown in FIG. 4A), a medium severity health indicator as a solid yellow hexagon (not shown in FIG. 4A), a high severity health indicator as a solid red hexagon (shown as a hexagon with vertical hashing in FIG. 4A), and an unmonitored component as a gray outlined hexagon (shown as an empty hexagon in FIG. 4A). The gray filled in hexagon may be information message related to the asset. One advantage of the component health card 408 is that it allows the user to see a list view of the main turbine components as well as the main turbine components' health indicators. Although not depicted in FIG. 4A, in some embodiments, the Component Health card 422, additionally or alternatively, displays a cross-sectional outline view of the outline of the turbine including outlines of several turbine components, such as the blade, the pitch system, the main bearing, the gearbox, the generator, the cooling system, the main shaft, the hydraulics, and the yaw system. The display module 224 shows the border and/or fill of each component in the corresponding health indicator color.

The Service Overview card 424 shows the last 12 months of service for the turbine in a service event list that displays the actual date, the service order number, and the details of each service event. The work order module 226 receives service events (both completed and open). In some embodiments, the work order module 226 receives service events from a work order system, which may be an internal work order system or an external work order system (i.e., external to the organization running the renewable energy asset monitoring system 104), and on a regular basis (e.g., daily). The user may toggle between completed and open service events using the completed/open radio button 432. If the user selects completed, the Service Overview card 424 shows completed service events. If the user selects open, the Service Overview card 424 shows service events for the next 12 months. One advantage of the Service Overview card 424 is that the user may quickly and easily toggle between completed and open service events. Further, the Service Overview card may assist the user to determine if a work order needs to be created and scheduled.

The Alerts card 426 displays a list of alerts for the turbine, with the following information about each alert: the Status 434, the Severity 436, the Type 438, the Component 440, the Received Date 442, the Lead-Time (Days) 444, and Action 446. The Status 434 may be any status described with respect to the Workflow Status card 342 of FIG. 3A. The Severity 436, in some embodiments, displays a high severity risk alert as a solid red hexagon (shown as a hexagon with vertical hashing in FIG. 4A), a medium severity risk alert as a solid orange hexagon (shown a hexagon with horizontal hashing in FIG. 4A), and a low severity risk alert as a solid yellow hexagon (shown as a hexagon with no hashing in FIG. 4A). The Type 438 may be any alert type as in the Alert Type dropdown 352 described with reference to FIG. 3B. The Component 440 displays the component having the subcomponent that generated the alert and is hyperlinked to a turbine component details user interface 500 described with reference to FIGS. 5A-C. The Received Date 442 displays the date the alert was received, the Lead-Time (Days) displays the amount of lead-time specific to the alert. The user may sort the alerts list using the arrows in the column headers. The user may export the list of alerts using the Export button 448 and page through the alerts using the page selector 450.

As shown in FIG. 4A, the selected turbine has an Open alert with a high severity risk level with an alert type of Gen DE Bearing, which is for the generator subcomponent DE Bearing, as well as an acknowledged alert with the same alert type and for the same generator subcomponent. The selected turbine also has two In Progress alerts of type Rotor Mechanical, which are for the generator subcomponent Rotor. An alert status of In Progress indicates that the work order module 226 has sent a work order to the work order system. In the Action column, the user may select the ellipsis and the display module 224 will display a popup (not shown in FIG. 4A) with four options: View Details, Acknowledge Alert, Send Initiation, and Close Alert. Whether an option is selectable depends on the alert status. For example, for an Open alert, all options are selectable. As another example, an Acknowledged alert has the View Details and the Close Alert options. An alert with a Closed status has the View Details option. For Open alerts, the user may select Send Notification, and doing so causes the work order module 226 to initiate a work order request to be sent to the work order system. In some embodiments, a user may tag the alert with failure mode and add a description. In one example, a user may tag an alert or data associated with a monitor when the failure mode is unclear.

If the user selects the View Details option, the display module 224 displays a modal window with alert details. FIG. 4B depicts an alert details user interface 460 for a renewable energy asset monitoring system in some embodiments. The alert details user interface 460 shows the unit ID type and the following information about the alert: the type, status, date received, and the lead-time in days. The alert details user interface 432 also provides instructions for the work order and hyperlinks to service manuals. The alert details user interface 460 also shows the alert activity. For example, the alert activity may include the date the alert was opened, the date the status changed from Open to In Progress, and the date the status was changed from In Progress to Closed. The alert details user interface 460 also displays a name of the user who made the status changes. One advantage of the alert details user interface 432 is that it may allow the user to keep track of what has happened with the alert and to easily access repair instructions and service manuals.

FIG. 5A depicts a turbine component details user interface 500 for a renewable energy asset monitoring system in some embodiments. The display module 224 displays the turbine component details user interface 500 when, for example, the user selects the Gearbox tab 408 or the Generator tab 410 of the turbine details user interface 400. The turbine component details user interface 500 has multiple cards including an Overview card 502, an Overall Health card 504, a Vibration health card 506, a Thermal health card 508, a Monitoring card 510, and a Subcomponent View card 512. In FIG. 5A, the content of the cards is for the generator component. The turbine component details user interface 500 also has a Monitoring Details card 514, which is discussed with reference to FIG. 5C.

The Overview card 502 lists the name of the farm, the geography, the status, and the local time of the turbine. The Overview card 502 also has data about the component including the type, the make, the model, the version, the serial number, and the install date. The reliability management module 228 may obtain some of this information using a background reliability management process, discussed with reference to FIG. 11. The Overview card 502 may be collapsed by the user selecting a Hide Details link 509. One advantage of the Overview card 502 is that it provides high-level information on the selected turbine component.

The Overall Health card 504 shows the component risk and age. The component risk may be either high, moderate or low. The report and alert module 220 bases component risk on the combination of the monitored subcomponent health indicators, component vibration health, and component thermal health. The display module 224 may show a high risk as a red square (shown with vertical hashing in FIG. 5A), a moderate risk as a orange square, and a low risk as a yellow square. The Vibration Health card 506 shows the Drive-end Risk and the Non-Drive-end Risk, which are based on an overall vibration descriptor for the component. The display module 224 displays Vibration Drive-end Risk and Non Drive-end Risk as either Low (green bars), Moderate (orange bars), or High (red bars). The Thermal Health card 508 shows the Thermal Drive-end and Non Drive-end Risk, which are based on temperature data modeling. The display module 224 displays Vibration Drive-end Risk and Non Drive-end Risk as either Low (green bars, shown as diagonal hashing in FIG. 5A), Moderate (orange bars), or High (red bars). If the data is not available for vibration health or thermal health, the display module 224 displays an indication that the data is not available.

The Monitoring card 510 has a list of monitored subcomponents for the generator component. The display module 224 displays each monitored subcomponent (e.g., Shaft, DE Bearing, Rotor, Rotor Connections, and NDE Bearing) and its corresponding alert level. A high severity risk is depicted using a solid red hexagon (shown with vertical hashing in FIG. 5A) a medium severity risk is depicted using a solid orange hexagon (shown with horizontal hashing in FIG. 5A), a low severity risk is depicted using a solid yellow hexagon (shown with diagonal hashing in FIG. 5A0, and a generally non-existent risk is shown as an empty green hexagon. The display module 224 displays an unmonitored component using an empty gray hexagon. The user may select a subcomponent to show the alerts for that particular subcomponent. For example, the Rotor subcomponent has a medium severity risk alert received Mar. 13, 2022. The user may select the Details hyperlink 516, and the display module 224 will display the Monitoring Details card 514.

The Subcomponent View card 512 depicts a cross-sectional outline view 518 of the outline of the generator including outlines of several generator subcomponents, such as the Shaft, the DE Bearing, the Rotor, the Rotor Connections, and the NDE bearing. The display module 224 shows the color of the border and/or fill of each subcomponent that corresponds to its alert severity in the cross-sectional outline view 518. The alert severity of the DE bearing is high and thus the display module 224 displays the DE Bearing as solid red (shown as with vertical hashing in FIG. 5A). The alert severity of the Rotor is medium and thus the display module 224 displays the Rotor as solid orange (shown as with horizontal hashing in FIG. 5A). The alert severity of the NDE Bearing is low and thus the display module 224 displays the NDE Bearing as solid yellow (shown as with diagonal hashing in FIG. 5A). The alert severity of the Shaft and the Rotor Connections is generally non-existent and thus the display module 224 displays the Shaft and the Rotor Connections using a green border and empty fill. The user may hover over a subcomponent and the display module 224 will display the component name and any alert information such as severity, type, and received date. In some embodiments, the display module 224 uses different colors to indicate alert severity of generator subcomponents. In some embodiments, the display module 224 uses different combinations of border and fill colors to indicate alert severities. One advantage of the monitoring card 510 and the subcomponent view card 512 is that they allow the user to see a list view of the alert severity of the generator subcomponents as well as a graphical depiction of the generator subcomponents with its subcomponents' alert levels visually indicated.

FIG. 5B depicts a turbine component details user interface 500 for a renewable energy asset monitoring system in some embodiments. The turbine component details user interface 500 of FIG. 5B, which is for the gearbox component, has the same cards as the turbine component details user interface 500 of FIG. 5A, which is for the generator component. The cards of the turbine component details user interface 500 of FIG. 5B display information for the gearbox component. The Vibration Health card 506 has Planetary Risk, IMS Risk and HSS Risk for the gearbox component. Vibration Planetary, IMS and HSS Risk are based on the overall vibration descriptor for the gearbox component. The Thermal Health card 508 also has Planetary Risk, IMS Risk and HSS Risk for the gearbox component. Thermal Planetary, IMS and HSS Risk are based on temperature data modeling for the gearbox component. In both cards the display module 224 displays Vibration Planetary, IMS Risk and HSS Risk as either Low (green bars), Moderate (orange bars), or High (red bars). If the data is not available for Vibration Health or Thermal Health, the display module 224 displays an indication that the data is not available.

The Monitoring card 510 shows the main subcomponents (e.g., HSS RE Bearing, HSS Gear Set, HSS NRE Bearing, Inline Filter, and Offline Filter) of the gearbox component along with the corresponding alert level. As depicted in FIG. 5B, both the HSS Gear Set and the HSS NRE Bearing have a high severity risk alert. The Subcomponent View card 512 depicts a cross-sectional outline view 518 of the outline of the gearbox including outlines of several gearbox subcomponents, such as the Main Shaft, the Planetary Gear, the HSS Gear Set, and the HSS NRE Bearing. The alert severity risk of the HSS Gear Set and the HSS NRE Bearing is high and thus the display module 224 displays both subcomponents as solid red (shown as with vertical hashing in FIG. 5B).

FIG. 5C depicts the Monitoring Details card 514 of the turbine component details user interface 500. The Monitoring Details card 514, which provides additional details for subcomponent alerts, has a Select Subcomponent dropdown 520, a Show Service toggle 522, an Alert Details region 524, a time window selector 532, multiple subcomponent data charts 526 (shown individually as 526a and 526b), multiple subcomponent data chart option groups 528 (shown individually as 528a and 528b), and an Analyze button 530. If the Gearbox tab 408 is active, the Select Subcomponent dropdown 520 has as options the Gearbox subcomponents alerts. If the Generator tab 410 is active, the Select Subcomponent dropdown 520 has as options the Generator subcomponents alerts. Each option has the name of the subcomponent (e.g., Rotor), the number of the alerts for that subcomponent (e.g., two), a visual indication of the highest (or generally highest) severity risk alert (e.g., a red solid hexagon), and the alert types nested below and a visual indication of the severity alert for the alert type (e.g., Rotor Mechanical with a solid red hexagon and Rotor Mechanical with solid orange hexagon).

The selected subcomponent alerts is the gearbox HSS NRE Bearing, which has a high severity risk alert. The alert details region 524 provides certain details about the alert, instructions to fix the alert, and reference documents, like the alert details user interface 460 discussed with reference to FIG. 4B.

As depicted in FIG. 5C, the monitoring details card 514 has three subcomponent data charts 526 (shown individually as 526a-526c), each of which has an associated subcomponent data chart option group 528 (shown individually as 528a-528c). The user may select what time window to see data for in the subcomponent data charts 526 using the time window selector 532. Each subcomponent data chart 526 depicts time series data for the generator DE bearing subcomponent, which may be vibration data, temperature data, or other time series data generated by sensors of the generator DE bearing subcomponent. The associated subcomponent data chart option groups 528 include options for display of the subcomponent data charts 526, such as whether to display the threshold for the component, or which power class data to chart. The model training module 212 may establish thresholds through control groups and clustering. Each control group establishes thresholds that are specific to the established cohort. When scaling the population, the cohort of new assets are mechanically similar. For cohorts that are not already identified, the model training module 212 may create an experiment group that aggregates the potentially significant features from both the control group and experiment group to evaluate how to categorize the subcomponent.

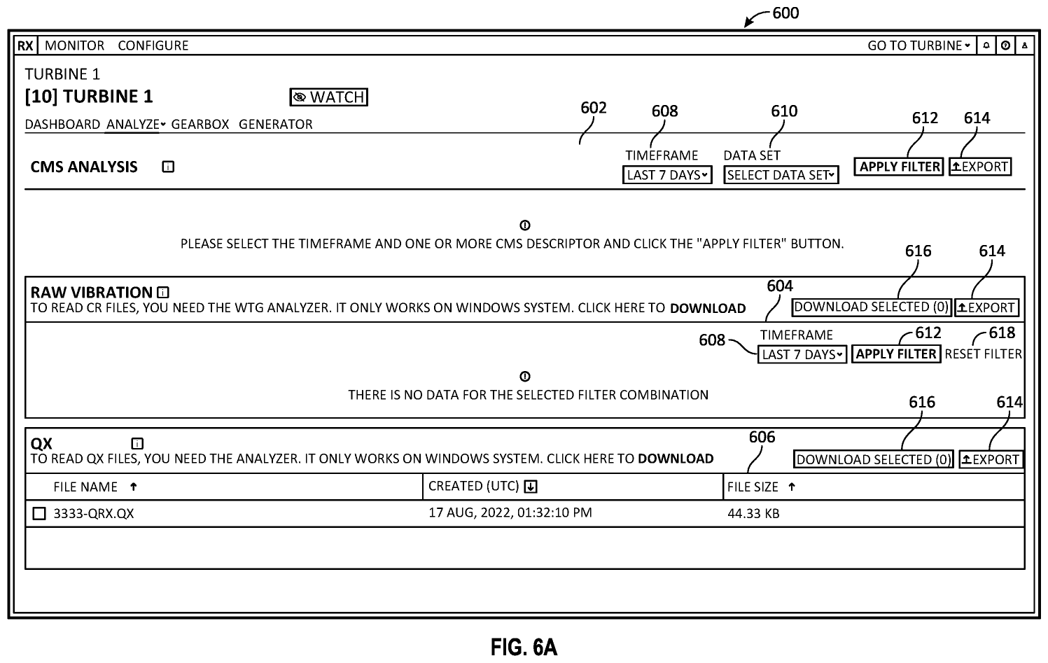

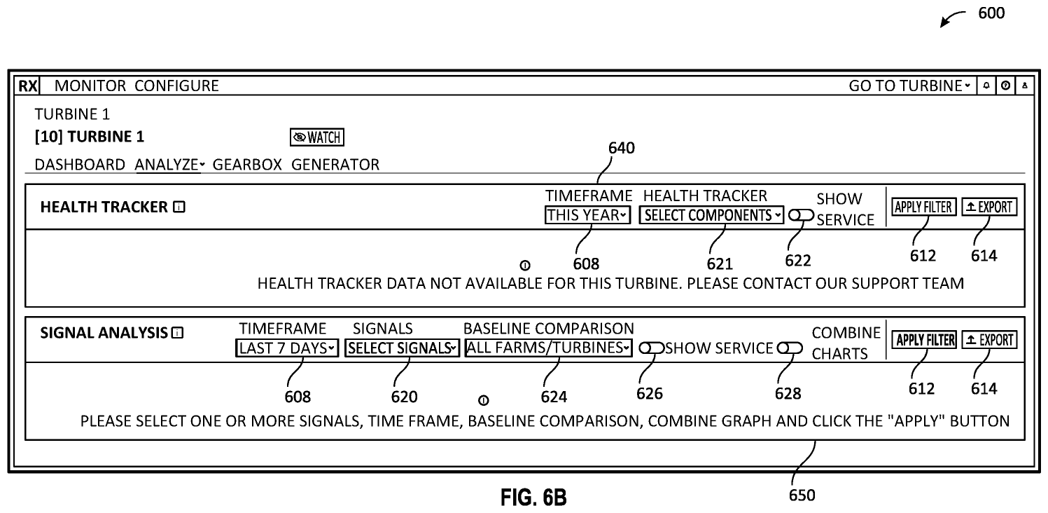

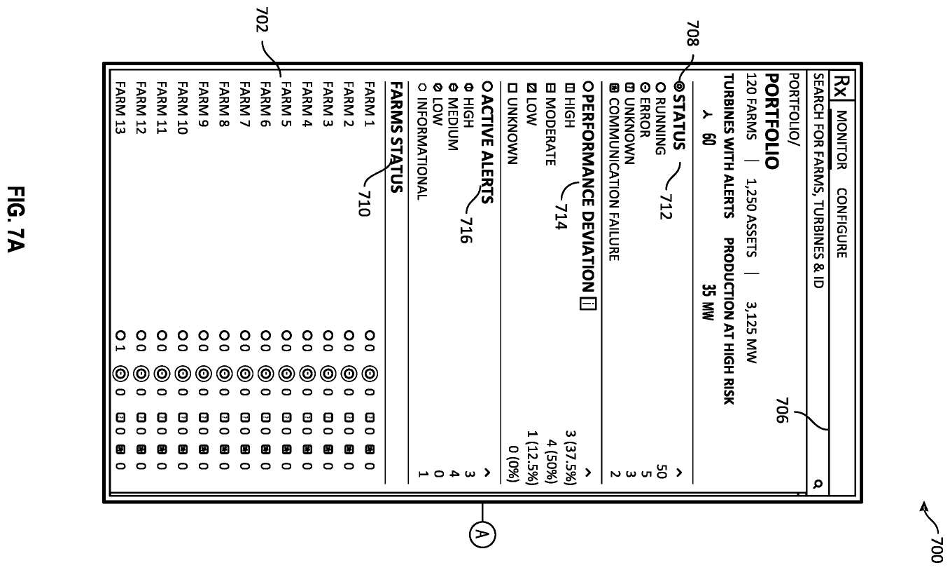

The user may toggle the display of service events on or off using the show service toggle 522. When the show service toggle 522 is on, the display module 224 displays service events as thin lines overlaid on the time series data on the subcomponent data charts 526. If the user hovers over a service event line, the display module 224 displays the date, the service order number, and a short description of the service event. One advantage of overlaying the service events on the time series data on the subcomponent data charts 526 is that it provides the user with the ability to see if a service event fixed an underlying issue. For example, a subcomponent data chart 526 may show that the time series data has recently exceeded the threshold, thus indicating a problem with the subcomponent. If a service event has fixed the underlying issue, the user will see a thin line overlaid on the subcomponent data chart 526 and then the time series data will drop below the threshold. However, if the service event has not fixed the underlying issue, then the user will see a thin line overlaid on the subcomponent data chart 526s but the time series data after the service event likely will not drop below the threshold and may rise even higher. The monitoring details card 514 also has an Analyze button 530. If the user selects the Analyze button 530 or the analyze tab 482, the display module 224 displays an analysis user interface, discussed with reference to FIG. 6A.

FIG. 6A depicts an analysis user interface 600 for a renewable energy asset monitoring system in some embodiments. The display module 224 displays the analysis user interface 600 when the user selects the Analyze button 530 of the monitoring details card 514 or the analyze tab 482 of the turbine details user interface 400. There are two options under the analyze tab 482: SCADA and CMS. The display module 224 may displays cards for CMS as the default, and the analysis user interface 600 includes a CMS Analysis card 602, a Raw Vibration (UFF) card 604, and a Kinematic (KINX) card 606. The CMS Analysis card 602 allows the user to select a timeframe 608 (e.g., the last seven days), a data set 610 (e.g., any data set associated with the selected subcomponent), and apply a filter using an apply filter button 612, which filters the displayed data based on the selected timeframe and the selected data set. The CMS Analysis card 602 also includes an export button 614 which allows the user to export the selected data set within the selected timeframe.

The Raw Vibration card 604 displays a list of information about compressed files, including the file name, the file creation timestamp (UTC), the active power (in kW), and the file size (in MB). The user may select one or more files and select a download selected button 616 to download the selected files. The user may also select a timeframe 608 (e.g., the last seven days, the last 30 days, the last 60 days, the last 90 days, the current month, the current year, or a custom timeframe), apply a filter using an apply filter button 612, which filters the displayed data based on the selected timeframe, and reset the filter using the reset filter link 618. The Raw Vibration card 604 also has an export button 614 which allows the user to export the data set within the selected timeframe. The card 606 (e.g., QX card 606) displays a list of information about QX files (e.g., any files including those specific to particular monitoring systems), including the file name, the file creation timestamp (UTC), and the file size (in MB). The user may select one or more files and select a download selected button 616 to download the selected files. The card 606 also has an export button 614 which allows the user to export the data set.

The second option under the analyze tab 482 is SCADA. When the user selects SCADA, the display module 224 changes the analysis user interface 600. While SCADA is used as an example, it will be appreciated that any number of options may be available for any kind of component monitoring or sensor data.

FIG. 6B depicts the analysis user interface 600 with two cards: a Health Tracker card 640 and a Signal Analysis card 650. The Health Tracker card 640 allows the user to select a timeframe 608 (e.g., the last seven days, the last 30 days, the last 60 days, the last 90 days, the current month, the current year, or a custom timeframe), a subcomponent 621, toggle the display of service events on or off using a show service toggle 622, and apply a filter using an apply filter button 612. When the user selects the apply filter button 612 the display module 224 filters the displayed data based on the selected timeframe and the selected subcomponent. The Health Tracker card 640 also includes an export button 614 which allows the user to export the data for the selected component within the selected timeframe.

While the Health Tracker card 640 depicted in FIG. 6B indicates that data is not available for a particular turbine, it will be appreciated that health data may be displayed in the card. FIG. 6C depicts health data that may appear in the Health Tracker card 640 in some embodiments.

The Signal Analysis Card 650 allows the user to select a timeframe 608 (e.g., the last seven days, the last 30 days, the last 60 days, the last 90 days, the current month, the current year, or a custom timeframe), signals 620 (e.g., environment signals, gearbox signals, generator signals, grid signals, hydraulic signals, machine signals, and main bearing signals), a baseline comparison 624 (e.g., with other turbines or farms), toggle the display of service events on or off using a show service toggle 626, combine charts using a combine charts toggle 628, and apply a filter using an apply filter button 612. When the user selects the apply filter button the display module 224 filters the displayed data based on the selected timeframe, signals, and baseline comparison. The Signal Analysis Card 650 also includes an export button 614 which allows the user to export the data for the selected component within the selected timeframe.

One advantage of the analysis user interface 600 is that it may reduce the need for users to access data from different systems and overlay and compare SCADA data (or any signal or component data), CMS data, operational data, and service data for researching a condition of a subcomponent. The analysis user interface 600 may provide\a single place where users may access relevant current and historical data to refine any analysis required and see it visually for quick decision making.

FIG. 7A depicts a map user interface 700 for a renewable energy asset monitoring system in some embodiments. The display module 224 displays the map user interface 700 when the user selects the globe icon and View on Map link 316 of FIG. 3A. The map user interface 700 includes a side information region 702 and a map display region 704. The user may collapse and expand the side information region 702 and may zoom and scroll the map display region 704.

When it is fully zoomed out, the map display region 704 displays a map of the world, with circular icons representing turbine farms and/or clusters of turbine farms. At a certain zoom level, the number in the center of circular icon is the number of farms in the cluster. The user may select a circular icon (e.g., circular icon 718) to zoom in on the circular icon location until each individual farm is represented by circular icon, and the number in the center of circular icon is the number of turbines in the farm. The user may further zoom in, and the map display region 704 shows individual turbines in farms, with each turbine represented by a circular icon as discussed with reference to FIG. 7B. The user may select a turbine and the display module 224 displays the turbine details user interface 400 discussed with reference to FIGS. 4A and 4B.

The side information region 702 has a search bar 706 which allows the user to search for farms, turbines and turbine ID. The side information region 702 also has a name of the collection of assets being monitored, the number of farms, the number of assets, total capacity in MW, the number of turbines with alerts, and the production at high risk in MW. The side information region 702 also has a radio button 708 for selecting either status 712, performance deviation 714, or active alerts 716 information to be displayed. The side information region 702 also has an information list 710 for displaying information corresponding to the selected option of the radio button 708.

The first option of the radio button 708 is status 712. If the user selects status 712, the display module 224 expands a status area and displays a count of turbines for each of the following statuses: 1) running, which is visually indicated by an empty green circle, 2) error, which is visually indicated by a red solid circle with a white horizontal dash, 3) unknown, which is visually indicated by a grey square with a question mark, and 4) communication failure, which is visually indicated by a grey square with an icon representing communication failure. The information list 710 displays a Farm Status header and a list of farms, with a count of the number of turbines for each of the four statuses.

If the user selects performance deviation 714, the display module 224 expands a performance deviation area and displays the number and percentage of turbines for each of the following performance deviations: 1) high, which is visually indicated by a red square, 2) moderate, which is visually indicated by an orange square, 3) low, which is visually indicated by a green square, and unknown, which is visually indicated by a gray square. Performance deviation may refer to the deviation in the turbine's performance under normal operating conditions when compared to its historical empirical power curves. The report and alert module 220 may generate performance deviation using a blended methodology using four different empirical power curves (Same Month Last Yr., Last 3 Months, Last 6 Months and Last 12 Months). The information list 710 displays a Farm Performance Deviation header and a list of farms, with a count of the number of turbines for each of the four performance deviations.

If the user selects active alerts 716, the display module 224 expands an active alerts area and displays the number of turbines for each of the following active alerts: 1) high, which is visually indicated by a solid red hexagon, 2) medium, which is visually indicated by an solid orange hexagon, 3) low, which is visually indicated by a solid yellow hexagon, and 4) informational, which is visually indicated by a gray hexagon. The information list 710 displays a Farm Active Alerts header and a list of farms, with a count of the number of turbines for each of the four active alerts.

FIG. 7B depicts the map user interface 700 that is zoomed in enough to display circular icons 718 of individual turbines in a farm. The active alerts 716 is selected. Accordingly, each turbine has the corresponding active alert visual indicator overlaid over its circular icon 718, which is a medium severity risk alert for both turbines. If the user selects performance deviation 714, the display module 224 changes the color of the border of the circular icon 718 to visually indicate the performance deviation of the turbine (e.g., red for high, yellow for moderate, green for low, and gray for unknown). If the user selects status 712, the display module 224 overlays the status visual indicator on the circular icon 718. In some embodiments, a circular icon depicted in FIG. 7B may be partially colored depending on the performance deviation (e.g., can be part red and part green).

One advantage of the map user interface 700 is that it provides a visual indicator of where clusters of problems may exist and provides an operational and performance comparison feature to analyze performance problems related to asset health. These features also allow the user to view their population at a summary level and to be able to drill down to a specific turbine using a simple search or a few clicks. The ability to zoom in and out actively enables the user to dynamically change their view at any time, which gives them real-time control of the information they need to see. Furthermore, the ability to navigate directly from the map user interface 700 to the turbine details user interface 400 may assist the user in quickly planning treatment of potentially critical turbine problems.

FIG. 8 depicts an account user interface 800 for a renewable energy asset monitoring system in some embodiments. The display module 224 generates the account user interface 800 after the user selects the account icon 314. The account user interface 800 has an account details tab 802 and a preferences tab 804. On the account details tab 802 the user may view and change their account details such as their password. On the preferences tab 804, there is an email subscriptions toggle 806, an alert type selector 808, a severity selector 810, and a save changes button 812. The user may select whether to be emailed monitoring notifications using the email subscriptions toggle 806. The user may select alerts for the gearbox component, generator component, gearbox subcomponents, or generator subcomponents to be notified using the component/subcomponent selector 808. The user may also select whether to be notified about high, medium, low, or informational severity alerts using the severity selector 810. If the user makes any changes, the user may save them by selecting the save changes button 812. The report and alert module 220 may store the user selections in data storage 222.

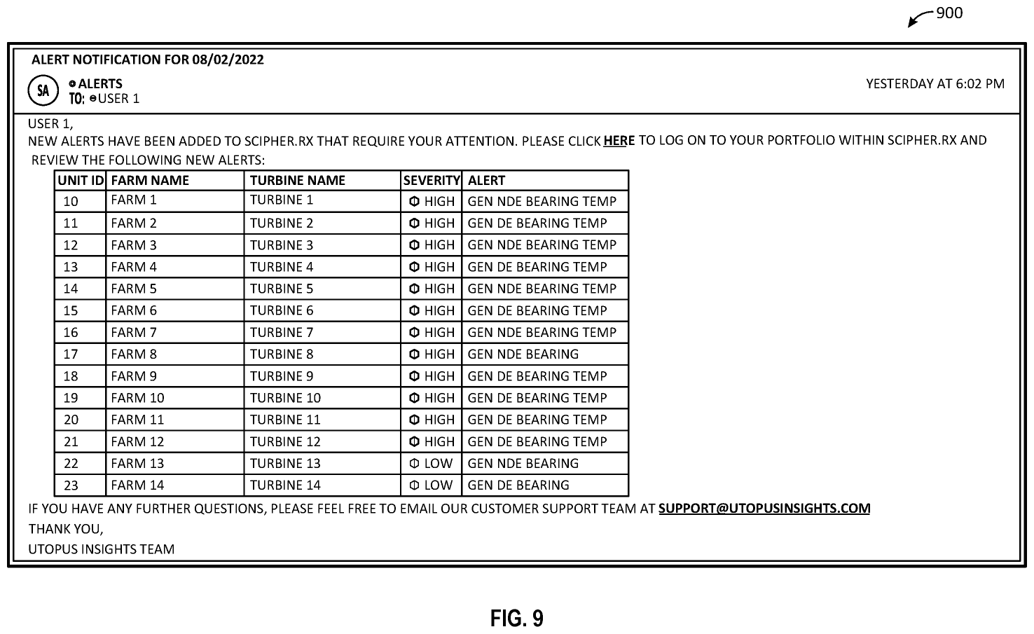

FIG. 9 depicts an email alert notification user interface 900 for a renewable energy asset monitoring system in some embodiments. The report and alert module 220 may generate alert notifications when a turbine alert is triggered in some embodiments. The display module 224 may generate the email alert notification user interface 900 when the report and alert module 220 generates alert notifications. The email alert notification user interface 900 has a table with the following columns: turbine unit ID, farm name, turbine name, alert severity along with a colored visual indication of the alert severity (e.g., solid red hexagon for high severity risk alert, solid orange hexagon for medium severity risk alert, solid yellow hexagon for low severity risk alert, and gray hexagon for informational alert), and alert subcomponent. The turbine unit ID and the turbine name are hyperlinked. The user may select a turbine unit ID or turbine name hyperlink, and the display module 224 displays the turbine details user interface 400 discussed with reference to FIGS. 4A and 4B. One advantage of the email alert notification user interface 900 is that it is emailed to the user on a periodic (e.g., hourly, daily, weekly) basis. The user thus may see new alerts that have triggered during that interval in their email software client. Another advantage is that the email alert notification user interface 900 allows the user to quickly access the turbine details user interface 400 and see more information about the turbine.

FIG. 10A depicts a configure alert user interface 1000 for a renewable energy asset monitoring system in some embodiments. The display module 224 may generate the configure alert user interface 1000. The configure alert user interface 1000 has a table with the following columns: alert ID, alert name, alert description, alert created by, alert creation date, alert modification date, and actions. Each alert may be expanded by a selection of the arrow to the left of the alert ID. The actions column has icons for three different actions, a view alert details icon 1002, an edit alert icon 1004, and a delete alert icon 1006. If the user selects the view alert details icon 1002. the display module 224 may generate a user interface that displays more information about the alert, such as the alert information specified using the create alert user interface 1040 of FIG. 10B. The user may select the edit alert icon 1004 to edit the details of the alert. The display module 224 may generate an update alert user interface, which is generally similar to a create alert user interface 1040 discussed with reference to FIG. 10B. The user may also select the delete alert icon 1006 to delete the alert. The report and alert module 220 performs the view alert details, edit alert, and delete alert functions.

The configure alert user interface 1000 also has an add alert button 1010. If the user selects the add alert button 1010, the display module 224 generates the create alert user interface 1040 depicted in FIG. 10B. The user may specify the alert details, including an alert name 1042, an alert description 1044. The user also selects an alert template 1046, which has options for signal specifications. The display module 224 populates the signal specification 1050 with the selected option from the alert template 1046. The user may select an alert severity 1048 (high, medium, low, or informational). The user selects an operator 1052 (e.g., mean_change, measurement, greater than, greater than or equal to, between, less than, and less than or equal to). The display module 224 allows the user to input values into the minimum threshold 1054, the maximum threshold 1056 and/or the alert count 1058 depending on the selected operator. The user may select farms and/or turbines using a select farms and turbines 1062 and enter instructions 1064. The user may reset 1066 the alert details and create the alert using create button 1068. The report and alert module 220 saves the alert in data storage 222.

For example, the user may set up an alert if the generator drive-end bearing (Gen DE Bearing) average temperature goes above a specific threshold (e.g., 80 degrees Celsius) for a period of time (e.g., three days). If the alert is triggered, the report and alert module 220 may notify the user of the alert (e.g., using the email alert notification user interface 900 and/or using the notification icon 310 of the summary user interface 300). One advantage of the create alert user interface 1040 is that it provides a platform for the user to set up conditional alerts for conditions that are of interest to the user, in addition or as an alternative to the predictive alerts described herein.

FIG. 11 depicts three flows diagram for reliability management for a renewable energy asset monitoring system in some embodiments. A first flow diagram is of a process 1100 for adding new turbines (also called onboarding turbines). The reliability management module 228 begins with phase 1102 by performing contract validation of the turbine and then performs master data validation of the turbine in phase 1104. For example, the reliability management module 228 may use relevant master data to determine if a turbine qualifies for monitoring, which includes, but is not limited to, sensor configuration, data availability and contractual obligations. In phase 1106, the reliability management module 228 performs validation of available data. In phase 1108, the reliability management module 228 validates data quality and clustering. In phase 1110, the reliability management module 228 performs turbine view and scoring scope updates. In phase 1112, the reliability management module 228 creates an application to add the turbine to professional services alerting templates.

A second flow diagram is of a process 1140 for removing turbines (also called offboarding turbines). The reliability management module 228 begins with phase 1142 by performing contract validation of the turbine. In phase 1144, the reliability management module 228 removes the turbine from scoring. In phase 1146, the reliability management module 228 creates an application to remove the turbine from professional services alerting templates. A third flow diagram is of a process 1150 that the reliability management module 228 performs when a component or subcomponent is serviced (e.g., after a work order). When the reliability management module 228 determines that a component or subcomponent has been serviced (including having been replaced), then the asset configuration will automatically be recalibrated or reset as necessary to enable effective monitoring of the component or subcomponent.

FIG. 12 is a flowchart for displaying health indicators for components and/or subcomponents of a renewable energy asset in some embodiments. In step 1202, the communication module 202 may receive first current sensor data of a first time period from multiple wind turbines in one or more wind turbine farms in one or more geographies.

In step 1204, the display module 224 may determine health indicators for the gearbox subcomponents corresponding to alerts for current or predicted problems of the gearbox subcomponents. The model application module 216 may apply a machine learning model as discussed herein (e.g., trained on second historical sensor data of a second time period, including sensor data from the gearbox subcomponents) to generate a forecast for a gearbox subcomponent. The trigger module 218 may compare the forecast to a threshold to determine at which point in a varying time window the forecast may exceed the threshold, if it does exceed the threshold. The report and alert module 220 may then determine the alert severity risk level (e.g., high severity risk, medium severity risk, low severity risk, or informational) for the generator subcomponent based on the determination at which point in the varying time window the forecast may exceed the threshold, if it does exceed the threshold. It will be appreciated that thresholds may not be the only values on a graph. For example, there may be a count of a number of occurrences of a particular indicator occurring over a period of time.

In step 1206, the display module 224 may determine health indicators for the generator subcomponents corresponding to alerts for current or predicted problems of the generator subcomponents. The model application module 216 may apply a machine learning model as discussed herein (e.g., trained on second historical sensor data of a second time period, including sensor data from the generator subcomponents) to generate a forecast for a generator subcomponent. The trigger module 218 may compare the forecast to a threshold to determine at which point in a varying time window the forecast may exceed the threshold, if it does exceed the threshold. The report and alert module 220 may then determine the alert severity risk level (e.g., high severity risk, medium severity risk, low severity risk, or informational) for the generator subcomponent based on the determination at which point in the varying time window the forecast may exceed the threshold, if it does exceed the threshold.

In step 1208, the communication module 202 may receive the health indicators for the gearbox subcomponents and the health indicators for the generator subcomponents.

In step 1210, the display module 224 may display a list of the multiple wind turbines along with the health indicators for the gearbox subcomponents and the health indicators for the generator subcomponents of the multiple wind turbines. The display module 224 may sort the list by health indicators for the gearbox subcomponents and/or health indicators for the generator subcomponents. The display module 224 may filter the list by alerts for the gearbox subcomponents and/or alerts for the generator subcomponents.

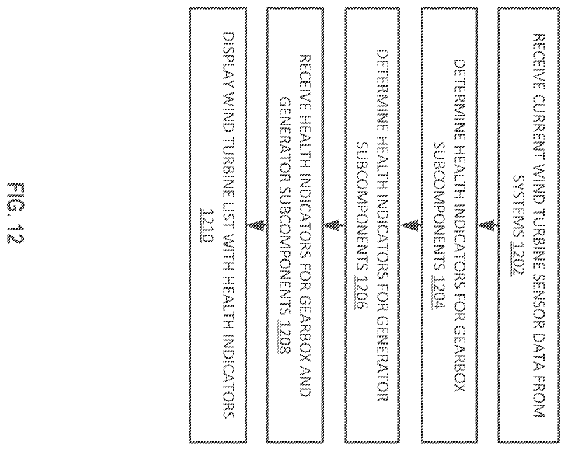

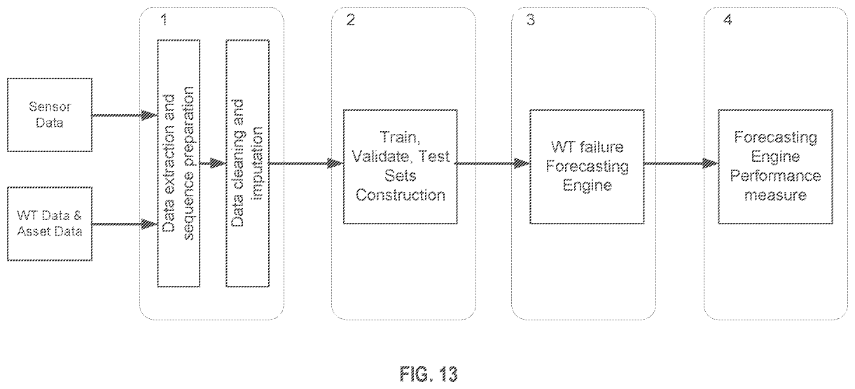

FIG. 13 depicts example phases of operation for failure prediction in some embodiments. Failure prediction may refer to detecting risk of failure (e.g., not necessarily the prediction of the failure itself). Modules discussed regarding FIG. 2 will also be discussed in the context of FIG. 13.

The communication module 202 may be configured to transmit and receive data between two or more modules in the renewable energy asset monitoring system 104. In some embodiments, the communication module 202 is configured to receive information regarding assets of the electrical network 102 (e.g., from the power system 106, sensors within components of the electrical network 102 such as the renewable energy sources 112, third-party systems such as government entities, other utilities, and/or the like).

The communication module 202 may be configured to receive failure data, asset data (e.g., wind turbine failure data & asset data), sensor data, and SCADA information (See phase 1 of FIG. 13). Failure data may indicate failure of a component or combination of components. While SCADA information is referred to in this example, it will be appreciated that the communication module may receive any data including SCADA information and/or other monitoring or sensor data. Further, in some embodiments, failure data may refer to data associated with failure of components (or subcomponents) and/or data associated with increased risk of failure of components (or subcomponents).

Failure data may include but is not limited to a turbine identifier (e.g., TurbineId), failure start time (e.g., FailureStartTime), failure end time (e.g., FailureEndTime), component, subcomponent, part, comments, and/or the like. The turbine identifier may identify a wind turbine or group of wind turbines. A failure start time may be a time where a failure (e.g., or increased risk of failure) of a component, subcomponent, or part of the wind turbine is first identified. A failure end time may be a time where a component, subcomponent, or part of the wind turbine is repaired or replaced.

The wind turbine asset data may include, but is not limited to, wind turbine generation, version, geolocation, and/or the like. Wind turbine generation may indicate an amount of power being generated. A version may be a version of a component, subcomponent, part, or wind turbine. The geolocation may indicate the geographic location of a wind turbine or group of wind turbines. Sensor data may be from sensors of electrical assets either individually or in combination (e.g., wind turbines, solar panels, windfarms, solar farms, components of devices, components of wind turbines, components of solar panels, substation(s) 114, transformer(s) 116, and/or transmission line(s) 110). The communication module 202 may further receive sensor data from one or more sensors of any number of electrical assets such as those described above. The sensor data may, in some embodiments, be received by a SCADA system and provided by a SCADA system (or any CMS system or sensor data as discussed herein).

The following refers to SCADA systems and related data. It will be appreciated that may data, including non-SCADA systems, may be received and analyzed. Supervisory control and Data Acquisition (SCADA) is a control system architecture often used to monitor and control aspects of hardware and software systems and networks. SCADA is one of the most commonly-used types of industrial control systems. SCADA may be used to provide remote access to a variety of local control modules which could be from different manufacturers which allows access through standard automation protocols. SCADA systems may be used to control large-scale processes at multiple sites and over large or small distances.

SCADA systems may be utilized for remote supervision and control of wind turbines and wind farms. For example, the SCADA system may enable control of any number of wind turbines in the wind farm (e.g., clusters of wind turbines, all wind turbines, or one wind turbine). The SCADA system may provide an overview of relevant parameters of each wind turbine including, for example, temperature, pitch angle, electrical parameters, rotor speed, yaw system, rotor velocity, azimuth angle, nacelle angle, and the like. The SCADA system may also allow remote access to the SCADA system to supervise and monitor any number of wind turbines of any number of wind farms.

The SCADA system may further log data regarding any number of the wind turbine such as failures, health information, performance, and the like. The SCADA system may allow access to the log data to one or more digital devices.

While examples of wind farms and wind turbines are discussed herein, it will be appreciated that SCADA systems may be utilized on any type of electrical asset or combination of different types of electrical assets including, for example, solar power generators, legacy electrical equipment, and the like.

SCADA system provide important signals for historical and present status of any number of wind turbines (WTs). However, an unmanageable number of alarms and event logs generated by a SCADA system is often ignored in wind turbine forecasting. Some embodiments of systems and method discussed herein leverages machine learning method(s) to extract a number of actionable insights from this valuable information.

SCADA sensors continuously monitor important variables of the wind turbine, environment, and the grid (e.g., temperature of various parts, active/reactive power generation, wind speed, rotation speed, grid frequency, voltage, current, and the like. The sensor data may be a multi-variant time series.

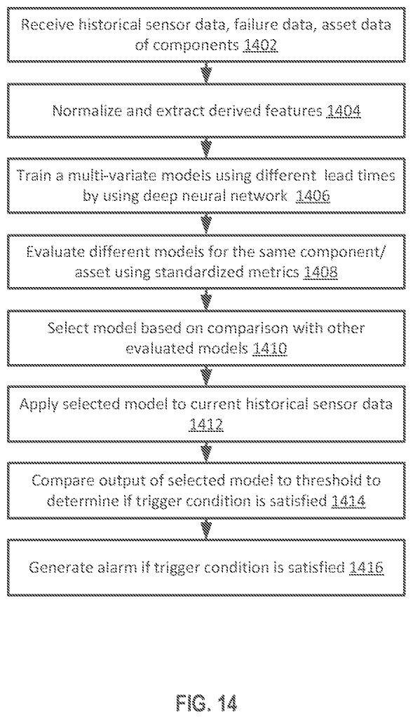

FIG. 14 is a flowchart for predicting failures and/or potential failures of renewable energy assets in some embodiments. In the example of FIG. 14, prediction failures and/or potential failures of wind turbines is discussed. In step 1402, the communication module 202 receives the historical sensor data, failure data, and asset data of any number of components of any number of electrical assets. In various embodiments, the component failure prediction system may generate any number of different failure prediction models for a set of failure prediction models, each set of failure prediction models being for each component, component group, type of component, type of component group, and/or the like. Each set of failure prediction models of the set of failure prediction models may vary in terms of the observation window (e.g., limited to a predetermined window of the historical data used to train a model) and/or lead time. Some embodiments of extracting information from SCADA information is further discussed regarding FIG. 15.

In step 1404, the data extraction module 204 and the data preparation module 206 may normalize and/or extract features (e.g., derived or not derived) from the received historical sensor data and other received data. As discussed herein, the data extraction module 204 and the data preparation module 206 may perform a data quality check for a predetermined percentage of sensor data which may reduce the number of values to a subset of sensors that provided data to the renewable energy asset monitoring system 104 during the relevant time period.

The data extraction module 204 and the data preparation module 206 may clean data by correcting for missing sensor data as discussed herein.

In various embodiments, the data extraction module 204 and the data preparation module 206 may define multiple lead time windows for different classes of lead time before an expected or actual failure (e.g., see three failure classes as discussed herein).

It will be appreciated that, in some embodiments, the data extraction module 204 and the data preparation module 206 may determine the observation window for a model to be trained. Historical sensor data may be received or extracted. The historical sensor data may have been generated during the observation window. The historical sensor data may be further processed. For example, the dimensionality of the historical sensor data may be reduced (e.g., using principal component analysis) and/or features extracted (e.g., columns or metrics) to train one or more failure prediction models of the set.

The validation module 210 may cross validate any number of models. As discussed herein, any amount of the received data may be divided. In some embodiments, n sub-subsets of data may be divided for training and tested against another sub-subset of data (e.g., the data divided into five subsets where four are used for training and a fifth is used for testing). The process may continue to train different models using a different set of the subsets with a different subset used for training for cross validation and scaling.

In step 1406, the model training module 212 trains any number of failure prediction models with different classes of lead times by using a deep neural network (e.g., FC, CNN, and RNN utilizing drop out and max pooling). It will be appreciated that any machine learning approach may be utilized including, for example, decision trees.

In step 1408, the model evaluation module 214 may evaluate every failure prediction model of a set of failure prediction models. For example, the model evaluation module 214 may evaluate every model that predicts failure of a generator of a wind turbine. Each model of the set may vary depending on the observation window and the lead time window used in generating the model.

The model evaluation module 214 may utilize standardized metrics as discussed herein to evaluate the models of the set of models. The model evaluation module 214 may utilize any or all of the following metrics including, but not limited to, Sensitivity, Recall, Hit Rate, or True Positive Rate (TPR), Specificity or True Negative Rate (TNR), Precision or Positive Predictive Value (PPV), Negative Predictive Value (NPV), Miss Rate or False Negative Rate (FNR), Fall-out or False Negative Rate (FNR), False Discovery Rate (FDR), False Omission Rate (FOR), Accuracy (ACC), the F1 score is the harmonic mean of precision and sensitivity, the Matthews correlation coefficient (MCC), the informedness or Bookmaker Informedness (BM), the Markedness (MK), and/or area under the curve (AUC).

In step 1410, the model evaluation module 214 may compare any number of the model evaluations of failure prediction models of a set of failure prediction models to any of the other set of model evaluations to select a preferred model of the set of models. It will be appreciated that each failure prediction model of a set may be compared using similar metrics and/or different metrics as described above. Based on the two different failure prediction models in this example, the model evaluation module 214 or authorized entity may select the failure prediction model with the longer lead time, higher AUC, train sensitivity, train precision, and train specificity even though the lookback time is larger.

In step 1412, the model application module 216 may receive current sensor data from the same components or group of components that provided the historical sensor data. The model application module 216 may apply the selected failure prediction model to the current sensor data to generate a prediction.

In step 1414, the trigger module 218 may compare the output of the selected failure prediction model to a threshold to determine if trigger conditions are satisfied 918. In other words, the trigger module 218 may compare a probability of accuracy or confidence of a predicted failure to a failure prediction threshold. In various embodiments, the trigger module 218 may store threshold triggers in a threshold trigger database. There may be different trigger thresholds for different components, component types, groups of components, groups of component types, assets, and/or asset types. In various embodiments, there may be different trigger thresholds depending on the amount of damage that may be caused to the asset by failure, other assets by failure, the electrical grid, infrastructure, property and/or life. There may be different trigger thresholds based on the selected model (e.g., based on sensitivity, accuracy, amount of lead time, predicted time of failure, and/or the like). The different trigger thresholds may be set, in some embodiments, by a power company, authorized individual, authorized digital device, and/or the like.

In step 1416, the report and alert module 220 may generate an alert if a trigger condition is satisfied. In some embodiments, the report and alert module 220 may have an alert threshold that must be triggered before the alert is issued. For example, the alert threshold may be based on the amount of damage that may be caused to the asset by failure, other assets by failure, the electrical grid, infrastructure, property and/or life. The alert may be issued by text, SMS, email, instant message, phone call, and/or the like. The alert may indicate the component, component group, type of component, type of component group, and/or the like that triggered the prediction as well as any information relevant to the prediction, like percentage of confidence and predicted time frame.

In various embodiments, a report is generated that may indicate any number of predicted failures of any number of components or groups of components based on application of selected models to different sensor data which may enable the system to provide a greater understanding of system health.

FIG. 15 is a flowchart for wind turbine failure forecasting using SCADA alarms and event logs in some embodiments. While the flowchart in FIG. 15 addresses the use of SCADA alarm and event logs in conjunction with training multiple failure prediction models of a set of models, it will be appreciated that systems and methods described herein may utilize SCADA alarm and event logs in conjunction with training one or more failure prediction models (e.g., without training and evaluating failure prediction models of a set of failure prediction models to select a preferred model).

In step 1502, the data extraction module 204 may receive event and alarm data from one or more systems used to supervise and monitor any number of wind turbines. The data extraction module 204 may include an input interface to receive detailed event and alarm logs as well as event and alarm metadata. The event and alarm logs may include, but are not limited to, a turbine identifier (e.g., turbineID), event code (e.g., EventCode), event type (e.g., EventType), event start time (e.g., EventStartTime), event end time (e.g., EventEndTime), component, subcomponent, and/or the like. The turbine identifier may be an identifier that identifies a particular wind turbine or group of turbines. An event code may be a code that indicates an event associated with performance or health of the particular wind turbine or group of turbines. The event type may be a classification of performance or health. An event start time may be a particular time that an event (e.g., an occurrence that affects performance or health) began and an event end time may be a particular time that the event ended. Components and subcomponents may include identifiers that identify one or more components or subcomponents that may be affected by the event.

The alarm metadata may include, but is not limited to, an event code (e.g., EventCode), description, and the like.

In one example, the event log includes a turbine identifier, an event code number, a turbine event type, an event start time (e.g., EventStartUTC) which identifies a time of a beginning of an event using universal time, an event end time (e.g., EventEndUTC) which identifies a time of an ending of an event using universal time), description, turbine event identifier, parameter 1, and parameter two.

In this example, the same wind turbine is undergoing four different events, including a change in wind speed, a change in pitch, a remote power setpoint change, and a generator outage.

Example event metadata example may include an event description and an event code. In various embodiments, the event metadata is not necessary for model development. In some embodiments, all or some of the event metadata may assist for model interpretation.

In step 1504, the data extraction module 204 may receive historical wind turbine component failure data and wind turbine asset metadata from one or more operational systems used to manage the operations of any number of wind turbines. The data extraction module 204 may include an input interface to receive the historical wind turbine component failure data and the wind turbine asset data. The historical wind turbine component failure data may include but not be limited to a turbine identifier (e.g., TurbineId), failure start time (e.g., FailureStartTime), failure end time (e.g., FailureEndTime), component, subcomponent, part, comments, and/or the like. The turbine identifier may identify a wind turbine or group of wind turbines. A failure start time may be a time where a failure of a component, subcomponent, or part of the wind turbine begins. A failure end time may be a time where a failed component, subcomponent, or part of the wind turbine (or a component, subcomponent, or part of the wind turbine at risk of failure) is repaired or replaced.

The wind turbine asset data may include, but is not limited to, wind turbine generation, version, geolocation, and/or the like. Wind turbine generation may indicate an amount of power being generated. A mark version may be a version of a component, subcomponent, part, or wind turbine. The geolocation may indicate the geographic location of a wind turbine or group of wind turbines.

In step 1506, the data extraction module 204 and/or the data preparation module 206 may conduct basic event data quality checks such as, but not limited to: daily availability check (e.g., minimum number of daily event code counts), event code option check (e.g., non-recognizable event), timestamp availability check, and/or the like. The data extraction module 204 and/or the data preparation module 206 may also conduct cleaning based on defined business rules (e.g., discard event data without start timestamp, and/or the like).

In step 1508, the data extraction module 204 and/or the data preparation module 206 may generate or extract cohorts for model development. A cohort may be a set of wind turbines having the same controller type and operating in a similar geography. In one example, example, the data extraction module 204 and/or the data preparation module 206 identifies similar or same controller types based on the asset data and the geolocation to generate any number of cohorts.

The data extraction module 204 and/or the data preparation module 206 may also identify both healthy time window WT instances and component risk time window WT instances from the failure data for any number of components, subcomponents, parts, and/or wind turbines.

In step 1510, the data extraction module 204 and/or the data preparation module 206 may generate an event and alarm vendor agnostic representation. In various embodiments, the data extraction module 204 and/or the data preparation module 206 receives the event and alarm logs as well as event and alarm metadata. In one example, data extraction module 204 and/or the data preparation module 206 may check whether the event and alarm logs as well as event and alarm metadata conform to standardized input interfaces.

The data extraction module 204 and/or the data preparation module 206 may modify the event and alarm log data from the event and alarm log and/or the alarm metadata to represent the event and alarm data in a vendor agnostic and machine-readable way (e.g., by structuring the event and alarm log data).

In step 1512, the data extraction module 204 and/or the data preparation module 206 may mine and discover patterns among the event and alarm data in the longitudinal history (e.g., patterns may be as simple as unique event code counts in a past time period such as a month, advanced time sequence patterns such as A→B→C, or complicated encoded event sequence vectors). In various embodiments, the data extraction module 204 and/or the data preparation module 206 may utilize the feature matrix(es) to discover patterns. The data extraction module 204 and/or the data preparation module 206 may provide the discovered patterns to other components of the renewable energy asset monitoring system 104.

In step 1514, the model training module 212 may receive patterns and/or the pattern matrix in addition to historical sensor data to train a set of failure prediction models. As discussed herein, each set of failure prediction models may be for a component, set of components, or the like.

In various embodiments, the model training module 212 may also receive features extracted from operational signals of one or more systems (e.g., SCADA systems and/or any type of sensor data). In some embodiments, an operational signal module (not depicted) may receive any number of operational signals regarding one or more operational systems. A longitudinal signal feature extraction module (not depicted) may optionally extract operational features from the operational signals and provide them to the model training module 212 to be utilized in addition to the patterns and/or the pattern matrix in addition to historical sensor data to train the set of models.

By leveraging operational logs and metadata using agnostic representations to derive patterns useful in machine learning, the failure prediction models may improve for accuracy and scalability. It will be appreciated that the event logs, alarm information, and the like generated by the sensor system may reduce processing time for model generation thereby enabling multiple failure prediction models to be generated in a timely matter (e.g., before the historical sensor data becomes scale) enabling scaling of the system yet with improved accuracy. It will be appreciated that generating a different failure prediction model for different components or groups of components of a set of wind turbines is computationally resource heavy and thereby may slow the process of model generation. This problem is compounded when creating a set of failure prediction models for each of the different components or groups of components of a set of wind turbines and evaluating different observation windows and lead times to identify preferred failure prediction models with better accuracy at desired lead times.

It will be appreciated that systems and methods described herein overcome the current challenge of using operational logs and metadata from different sources and utilizing the information to improve scalability and improve accuracy of an otherwise resource-intensive process, thereby overcoming a technological hurdle that was created by computer technology.

As discussed herein, the model training module 212 may generate any number of prediction models using the historical sensor data, the patterns, and different configurations for lead and observation time windows. For example, the model training module 512 may generate different failure prediction models for a component or set of components using different amounts of historical sensor data (e.g., historical sensor data generated over different time periods), using different patterns (based on event and alarm logs and/or metadata generated during different time periods), and with different lead lookahead times.

The model evaluation module 214 may evaluate any or all of the failure prediction models of a set generated by the model training module 212 to identify a preferred failure prediction model in comparison to the other preferred failure prediction models of the set and preferred criteria (e.g., longer lead times are preferred). The model evaluation module 214 may retrospectively evaluate failure prediction models on training, validation (including cross-validation) and testing data sets, and provide performance measure and confidence reports, including but not limited to AUC, accuracy, sensitivity, specificity and precision, and/or the like.

In various embodiments, the model evaluation module 214 may evaluate each failure prediction model of a set of failure prediction models for each component, component type, part, group of components, assets, and/or the like as discussed herein.

In various embodiments, model evaluation module 214 may assess a performance curvature to assist in selection of a preferred failure prediction model of a set. The performance look-up gives an expected forecasting outcome for a given lead time requirement. The performance look-up gives a reasonable lookback and lead time that an operator can expect.

In various embodiments, the renewable energy asset monitoring system 104 may generate the performance curvature, including the lookback and lead times to enable a user or authorized device to select a point along the performance curvature to identify and select a model with an expected forecasting outcome.

The model application module 216 may be configured to apply a preferred or selected failure prediction model (in comparison with other failure prediction models and selected by the model evaluation module 214 and/or an entity authorized to make the selection based on comparison of evaluation with any number of other generated models) to current (e.g., new) sensor data received from the same wind turbine or renewable asset equipment that was used to produce the sensor data of the previous received historical data.

There may be any number of selected failure prediction models, each of the selected failure prediction models being for a different component, component type, groups of components, groups of component type, asset, and/or asset type.

In various embodiments, the model application module 216 may compare new sensor data to classified and/or categorized states identified by the selected failure prediction model to identify when sensor data indicates a failure state, or a state associated with potential failure is reached. In some embodiments, the model application module 216 may score the likelihood or confidence of such estate being reached. The model application module 216 may compare the confidence or score against a threshold in order to trigger an alert or report. In another example, the model application module 216 may compare the fit of sensor data to a failure state or state associated with potential failure that has been identified by the model of the model application module 216 in order to trigger or not trigger an alert or report.

If there is damage to one or more generator bearing subcomponents, it may be useful to avoid consequential damage to other generator subcomponents or gearbox subcomponents. The model application module 216 may estimate a remaining safe period for the generator bearing subcomponents where the turbine can further operate without a high probability of causing damage on other generator subcomponents or gearbox subcomponents and without a high probability of failure in the one or more generator bearing subcomponents. The model application module 216 may utilize a threshold which can separate safe and unsafe conditions, and estimate how much time it takes to reach the un-safe vibration level.

The model application module 216 may provide a lead-time for each of the detected faults, and the lead-time should be a number representing the number of days until an unsafe operational zone is reached. The model evaluation module 214 may validate the lead-time using actual failure data, which may be end to end performance data based on ground truth and/or subcomponent validation based on ground truth (e.g., threshold validation based on failure events and/or forecast validation based on vibration data).

The trigger module 218 may establish thresholds for different components, component types, groups of components, groups of component types, assets, and/or asset types. Each threshold may be compared to an output of one or more selected failure prediction models. Thresholds may be established based on the performance of the selected model in order to provide an alarm based on likelihood (e.g., confidence) of prediction, seriousness of fault, seriousness of potential effect of the fault (e.g., infrastructure or life threatened), lead time of fault, and/or the like.

It will be appreciated that there may be different categorized states identified during model training. Each categorized state may be associated with a different type of failure including mode of failure, component of failure, and/or the like.

The report and alert module 220 may generate an alert based on the evaluation of the model evaluation module 214. An alert may be a message indicating a failure or type of failure as well as the specific renewable energy asset (e.g., wind turbine or solar panel) that may be at risk of failure. Since the state identified by the failure prediction model is a state that is in advance of a potential failure, the alert should be triggered in advance of the potential failure such that corrective action may take place. In some embodiments, different alerts may be generated based on different possible failure and or different failure states. For example, some failure states may be more serious than others, as such more alerts and/or additional detailed alerts may be provided to a larger number of digital devices (e.g., cell phones, operators, utility companies, service computers, or the like) depending on the seriousness, significance, and/or imminence of failure.

In some embodiments, the report and alert module 220 may generate a report indicating any number of potential failures, the probability of such failure, and the justification or reasoning based on the model and the fit of previously identified states associated with future failure of components. The report may be a maintenance plan or schedule to correct the predicted fault (e.g., preferably before failure and a minimum of power disruption).

The data storage 222 may be any type of data storage including tables databases or the like. The data storage 222 may store models, historical data, current sensor data, states indicating possible future failure, alerts, reports, and/or the like.

The report and alert module 220 may be modified to provide actional insights within a report or alert.

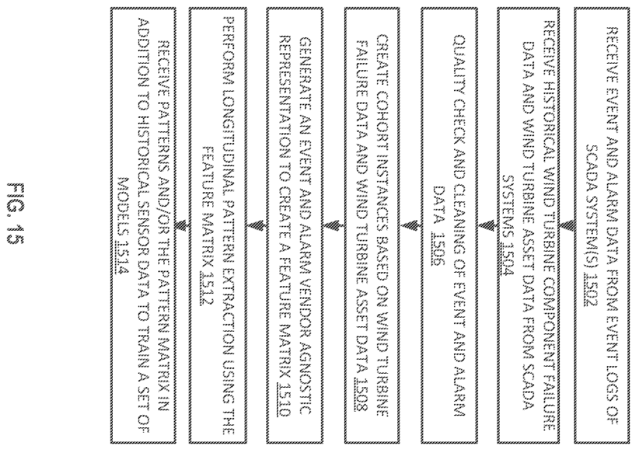

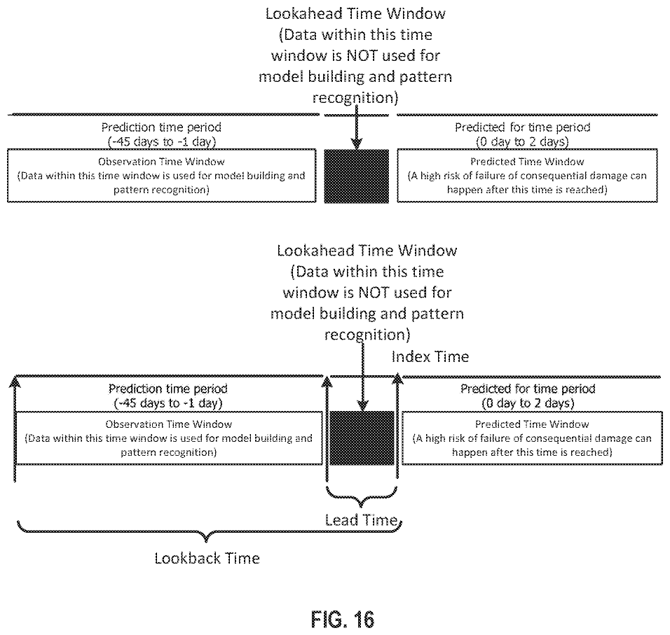

FIG. 16 characterizes problems and proposes solutions in some embodiments. The graph in FIG. 16 depicts sensor readings from multiple sensors over a period of time leading up to failure. The time before the failure is indicated as “lead time.” One goal may be to improve lead time with sufficient accuracy such that alerts may be issued and/or actions taken to mitigate consequences of failure or avoid failure prior to that failure occurring.

FIG. 16 is an example longitudinal evaluation framework for failure prediction. The longitudinal evaluation framework includes three periods of time, including a prediction time period, a lookahead time window, and a predicted for time period. In some embodiments, sensor data received and/or generated during the prediction time period may be used for model building and pattern recognition. Failure event labels may be extracted from the duration of the predicted time window.

The prediction time period is an observation time window where historical sensor data that was generated by sensors during this time window and/or received during this time window is used for failure prediction model building and pattern recognition for different models (e.g., with different amounts of lookback time). The lookahead time window is a period of time when sensor data generated during this time window and/or received during this time window is not used for model building and pattern recognition. In various embodiments, sensor data generated and/or received during the ahead time window may be used to test any or all failure prediction models. The predicted time window is a time period where there is a high risk of failure or consequential damage.

In the example of FIG. 16, the prediction time period is −45 days to −1 day (prior to the lookahead time window) and the predicted time window is 0 to 2 days after the lookahead time window. Different failure prediction models may be generated with different amounts of prediction time periods (e.g., different models use a different number of days of sensor data) and different amounts of lookahead times (e.g., different models use a different number of days before predicted failure).

It will be appreciated that the predicted time period may be any length of time prior to the lookahead time window and that the predicted time window can be any length of time after the lookahead time window. One of the goals in some embodiments described herein is to achieve an acceptable level of accuracy of a model with a sufficient lead time before the predicted time window to enable proactive actions to prevent failure or consequential damage, to scale the system to enable detection of a number of component failures, and to improve the accuracy of the system (e.g., to avoid false positives).

Further, as used herein, a model training period may include a time period used to select training instances. An instance is a set of time series/event features along with the failure/non-failure of a particular component in a renewable energy asset (e.g., a wind turbine) in a specified time period. A model testing period is a time period used to select testing instances.

In phase 1 as depicted in FIG. 16, the data extraction module 204 extracts data and prepares sequences. The way data is extracted may have the advantage of making a better use of limited number of failure data.

The data extraction module 204 may extract data sequences from received data by means of a rolling observation window (e.g., rolling observation time window). Data instance contains sensor signals from an observation window. For example, if the observation window length is 12 days, then to predict the failure probability at time t, we need the sensors data from t−12 days up to time t. New data samples are generated by moving the observation window with a fixed stride value.

After extracting the data samples, the data preparation module 206 cleans the data to make it ready for feeding to a machine training model (e.g., one or more neural networks). There may be two types of missing values in sensor signals. The first type of missing values in sensor signals is when one sensor has missing values for the whole observation window or a portion within the observation window. In this case, the data preparation module 206 may impute the missing value by replacing that with the most similar available signal. For example, if the missing value is one of the voltage sensors, the data preparation module 206 replaces that with the voltage of other phases, or if the missing value is the temperature of a subcomponent, the data preparation module 206 replaces that with a temperature of a neighboring subcomponent.

FIG. 17 depicts a block diagram of an example digital device 1700 according to some embodiments. Digital device 1700 is shown in the form of a general-purpose computing device. Digital device 1700 includes processor 1702, RAM 1704, communication interface 1706, input/output device 1708, storage 1710, and a system bus 1712 that couples various system components including storage 1710 to processor 1702.

System bus 1712 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Digital device 1700 typically includes a variety of computer system readable media. Such media may be any available media that is accessible by the renewable energy asset monitoring system 104 and it includes both volatile and nonvolatile media, removable and non-removable media.

In some embodiments, processor 1702 is configured to execute executable instructions (e.g., programs). In some embodiments, the processor 1702 comprises circuitry or any processor capable of processing the executable instructions.

In some embodiments, RAM 1704 stores data. In various embodiments, working data is stored within RAM 1704. The data within RAM 1704 may be cleared or ultimately transferred to storage 1710.

In some embodiments, communication interface 1706 is coupled to a network via communication interface 1706. Such communication may occur via Input/Output (I/O) device 1708. Still yet, renewable energy asset monitoring system 104 can communicate with one or more networks such as a local area network (LAN), a general wide area network (WAN), and/or a public network (e.g., the Internet).

In some embodiments, input/output device 1708 is any device that inputs data (e.g., mouse, keyboard, stylus) or outputs data (e.g., speaker, display, virtual reality headset).

In some embodiments, storage 1710 can include computer system readable media in the form of volatile memory, such as read only memory (ROM) and/or cache memory. Storage 1710 may further include other removable/non-removable, volatile/non-volatile computer system storage media. By way of example only, storage 1710 can be provided for reading from and writing to a non-removable, non-volatile magnetic media. The storage 1710 may include non-transitory media that stores programs or applications for performing functions such as those described regarding FIG. 2. Although not shown, a magnetic disk drive for reading from and writing to a removable, non-volatile magnetic disk (e.g., a “floppy disk”), and an optical disk drive for reading from or writing to a removable, non-volatile optical disk such as a CDROM, DVD-ROM or other optical media can be provided. In such instances, each can be connected to system bus 1712 by one or more data media interfaces. As will be further depicted and described below, storage 1710 may include at least one program product having a set (e.g., at least one) of program modules that are configured to carry out the functions of embodiments of the invention. In some embodiments, RAM 1704 is found within storage 1710.

Program/utility, having a set (at least one) of program modules, such as renewable energy asset monitoring system 104, may be stored in storage 1710 by way of example, and not limitation, as well as an operating system, one or more application programs, other program modules, and program data. Each of the operating systems, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with renewable energy asset monitoring system 104. Examples include, but are not limited to: microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of one or more embodiments may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

1. A non-transitory computer readable medium comprising executable instructions, the executable instructions being executable by one or more processors to perform a method, the method comprising:
receiving first current sensor data of a first time period from multiple wind turbines in one or more wind turbine farms in one or more geographies, a wind turbine including a gearbox and a generator, the gearbox including a first gearbox bearing subcomponent, a gear set subcomponent, and a second gearbox bearing subcomponent, and the generator including a first generator bearing subcomponent, a rotor subcomponent, and a second generator bearing subcomponent; the first current sensor data including sensor data from sensors monitoring the gearbox subcomponents and the generator subcomponents;
determining health indicators for the gearbox subcomponents, the health indicators corresponding to alerts for current or predicted problems of the gearbox subcomponents with varying lead time, the alerts including a low severity risk alert, a medium severity risk alert, and a high severity risk alert, the alerts being generated by a machine learning model trained on second historical sensor data of a second time period, including sensor data from the gearbox subcomponents;
determining health indicators for the generator subcomponents, the health indicators corresponding to alerts for current or predicted problems of the generator subcomponents with varying lead time, the alerts including a low severity risk alert, a medium severity risk alert, and a high severity risk alert, the alerts being generated by a machine learning model trained on second historical sensor data of a second time period, including sensor data from sensors monitoring the generator subcomponents;
receiving the health indicators for the gearbox subcomponents and the health indicators for the generator subcomponents; and
displaying a list of the multiple wind turbines, the health indicators for the gearbox subcomponents and the health indicators for the generator subcomponents, the list being sortable by health indicators for the gearbox subcomponents and/or by the health indicators for the generator subcomponents, and the list being filterable by alerts for the gearbox subcomponents and/or alerts for the generator subcomponents.

2. The non-transitory computer readable medium of claim 1, the method further comprises:
receiving a selection to filter the list of the multiple wind turbines by one or more alerts for at least one gearbox subcomponent and/or for at least one generator subcomponent;
filtering the list of the multiple wind turbines to include wind turbines with the selected one or more alerts for at least one gearbox subcomponent and/or for at least one generator subcomponent; and
displaying in the list wind turbines with the selected one or more alerts for at least one gearbox subcomponent and/or for at least one generator subcomponent.

3. The non-transitory computer readable medium of claim 1, the method further comprises:
receiving a selection of a wind turbine, the wind turbine having a health indicator for a gearbox subcomponent or a generator subcomponent corresponding to either a low severity risk alert, a medium severity risk alert, or a high severity risk alert;
receiving alert status and date information for the gearbox subcomponent or the generator subcomponent of the wind turbine; and
displaying the health indicator, the alert status and the date information for the gearbox subcomponent or the generator subcomponent of the wind turbine.

4. The non-transitory computer readable medium of claim 3, the method further comprises:
receiving a selection of the gearbox of the wind turbine;
determining an overall health indicator of the gearbox, the overall health indicator based at least in part upon any alerts for the gearbox subcomponents;
displaying the overall health indicator of the gearbox;
determining an overall health indicator of the generator, the overall health indicator based at least in part upon any alerts for the generator subcomponents; and
displaying the overall health indicator of the generator.

5. The non-transitory computer readable medium of claim 3, the method further comprises:
receiving a request to initiate a work order for the gearbox subcomponent or the generator subcomponent of the wind turbine; and
sending the work order to a work order system.

6. The non-transitory computer readable medium of claim 3, the method further comprises:
receiving completed service events for the wind turbine for a third historical time period the completed service events including completion date and service detail information;
receiving open service events for the wind turbine for a fourth future time period; the open service events including date and service detail information; and
displaying either the completed service events or the open service events.

7. The non-transitory computer readable medium of claim 3, the method further comprises:
receiving a selection of the gearbox or the generator;
determining which gearbox subcomponents or generator subcomponents are monitored by sensors and which gearbox subcomponents or generator subcomponents are not monitored by sensors;
displaying a list of the gearbox subcomponents or generator subcomponents, for the gearbox subcomponents or generator subcomponents that are monitored by sensors, the health indicators for the gearbox subcomponents or generator subcomponents, and for the gearbox subcomponents or generator subcomponents that are not monitored by sensors, indications that the gearbox subcomponents or generator subcomponents are not monitored by sensors; and
displaying a cross-sectional outline view of the outline of the gearbox or generator, the outlines of the gearbox subcomponents or generator subcomponents, the health indicators of the gearbox subcomponents or generator subcomponents that are monitored by sensors, and the indications that the gearbox subcomponents or generator subcomponents are not monitored by sensors.

8. The non-transitory computer readable medium of claim 3, the method further comprises:
determining a status of the selected wind turbine;
receiving the status of the wind turbine; and
displaying on a zoomable and scrollable map an icon for the selected wind turbine and an indication of the status of the selected wind turbine.

9. The non-transitory computer readable medium of claim 3, the method further comprises:
receiving a selection of a gearbox subcomponent alert or a generator subcomponent alert;
receiving time series data for the selected gearbox subcomponent;
displaying the time series data in one or more data charts;
receiving a request to display one or more service events for the wind turbine; and
displaying the one or more service events overlaid on the time series data in the one or more data charts.

10. The non-transitory computer readable medium of claim 1, the method further comprises:
receiving a request to analyze data for the wind turbine, the data including one or more of temperature data, signals data, CMS data, and vibration data;
receiving one or more of the temperature data, signals data, CMS data, and vibration data; and
displaying an analysis of the one or more temperature data, signals data, CMS data, and vibration data.

11. The non-transitory computer readable medium of claim 1, the method further comprises:
receiving a request to display the multiple wind turbines in one or more wind turbine farms in one or more geographies in a map;
displaying a map of the multiple wind turbines in one or more wind turbine farms in one or more geographies;
receiving status, performance deviation and/or active alerts for the multiple wind turbines; and
displaying status, performance deviation and/or active alerts for the multiple wind turbines grouped by the one or more wind turbine farms.

12. A system, comprising at least one processor; and memory containing instructions, the instructions being executable by the at least one processor to:
receive first current sensor data of a first time period from multiple wind turbines in one or more wind turbine farms in one or more geographies, a wind turbine including a gearbox and a generator, the gearbox including a first gearbox bearing subcomponent, a gear set subcomponent, and a second gearbox bearing subcomponent, and the generator including a first generator bearing subcomponent, a rotor subcomponent, and a second generator bearing subcomponent; the first current sensor data including sensor data from sensors monitoring the gearbox subcomponents and the generator subcomponents;
determine health indicators for the gearbox subcomponents, the health indicators corresponding to alerts for current or predicted problems of the gearbox subcomponents with varying lead time, the alerts including a low severity risk alert, a medium severity risk alert, and a high severity risk alert, the alerts being generated by a machine learning model trained on second historical sensor data of a second time period, including sensor data from the gearbox subcomponents;
determine health indicators for the generator subcomponents, the health indicators corresponding to alerts for current or predicted problems of the generator subcomponents with varying lead time, the alerts including a low severity risk alert, a medium severity risk alert, and a high severity risk alert, the alerts being generated by a machine learning model trained on second historical sensor data of a second time period, including sensor data from sensors monitoring the generator subcomponents;
receive the health indicators for the gearbox subcomponents and the health indicators for the generator subcomponents; and
display a list of the multiple wind turbines, the health indicators for the gearbox subcomponents and the health indicators for the generator subcomponents, the list being sortable by health indicators for the gearbox subcomponents and/or by the health indicators for the generator subcomponents, and the list being filterable by alerts for the gearbox subcomponents and/or alerts for the generator subcomponents.

13. The system of claim 12, the instructions being further executable by the at least one processor to:
receive a selection to filter the list of the multiple wind turbines by one or more alerts for at least one gearbox subcomponent and/or for at least one generator subcomponent;
filter the list of the multiple wind turbines to include wind turbines with the selected one or more alerts for at least one gearbox subcomponent and/or for at least one generator subcomponent; and
display in the list wind turbines with the selected one or more alerts for at least one gearbox subcomponent and/or for at least one generator subcomponent.

14. The system of claim 12, the instructions being further executable by the at least one processor to:
receive a selection of a wind turbine, the wind turbine having a health indicator for a gearbox subcomponent or a generator subcomponent corresponding to either a low severity risk alert, a medium severity risk alert, or a high severity risk alert;
receive alert status and date information for the gearbox subcomponent or the generator subcomponent of the wind turbine; and
display the health indicator, the alert status and the date information for the gearbox subcomponent or the generator subcomponent of the wind turbine.

15. The system of claim 14, the instructions being further executable by the at least one processor to:
receive a selection of the gearbox of the wind turbine;
determine an overall health indicator of the gearbox, the overall health indicator based at least in part upon any alerts for the gearbox subcomponents;
display the overall health indicator of the gearbox;
determine an overall health indicator of the generator, the overall health indicator based at least in part upon any alerts for the generator subcomponents; and
display the overall health indicator of the generator.

16. The system of claim 14, the instructions being further executable by the at least one processor to:
receive a request to initiate a work order for the gearbox subcomponent or the generator subcomponent of the wind turbine; and
send the work order to a work order system.

17. The system of claim 14, the instructions being further executable by the at least one processor to:
receive completed service events for the wind turbine for a third historical time period the completed service events including completion date and service detail information;
receive open service events for the wind turbine for a fourth future time period; the open service events including schedule date and service detail information; and
display either the completed service events or the open service events.

18. The system of claim 14, the instructions being further executable by the at least one processor to:
receive a selection of the gearbox or the generator;
determine which gearbox subcomponents or generator subcomponents are monitored by sensors and which gearbox subcomponents or generator subcomponents are not monitored by sensors;
display a list of the gearbox subcomponents or generator subcomponents, for the gearbox subcomponents or generator subcomponents that are monitored by sensors, the health indicators for the gearbox subcomponents or generator subcomponents, and for the gearbox subcomponents or generator subcomponents that are not monitored by sensors, indications that the gearbox subcomponents or generator subcomponents are not monitored by sensors; and
display a cross-sectional outline view of the outline of the gearbox or generator, the outlines of the gearbox subcomponents or generator subcomponents, the health indicators of the gearbox subcomponents or generator subcomponents that are monitored by sensors, and the indications that the gearbox subcomponents or generator subcomponents are not monitored by sensors.

19. The system of claim 14, the instructions being further executable by the at least one processor to:
receive a request to display the multiple wind turbines in one or more wind turbine farms in one or more geographies in a map;
display a map of the multiple wind turbines in one or more wind turbine farms in one or more geographies;
receive status, performance deviation and/or active alerts for the multiple wind turbines; and
display status, performance deviation and/or active alerts for the multiple wind turbines grouped by the one or more wind turbine farms.

20. A method comprising:
receiving first current sensor data of a first time period from multiple wind turbines in one or more wind turbine farms in one or more geographies, a wind turbine including a gearbox and a generator, the gearbox including a first gearbox bearing subcomponent, a gear set subcomponent, and a second gearbox bearing subcomponent, and the generator including a first generator bearing subcomponent, a rotor subcomponent, and a second generator bearing subcomponent, the first current sensor data including sensor data from sensors monitoring the gearbox subcomponents and the generator subcomponents;
determining health indicators for the gearbox subcomponents, the health indicators corresponding to alerts for current or predicted problems of the gearbox subcomponents with varying lead time, the alerts including a low severity risk alert, a medium severity risk alert, and a high severity risk alert, the alerts being generated by a machine learning model trained on second historical sensor data of a second time period, including sensor data from the gearbox subcomponents;
determining health indicators for the generator subcomponents, the health indicators corresponding to alerts for current or predicted problems of the generator subcomponents with varying lead time, the alerts including a low severity risk alert, a medium severity risk alert, and a high severity risk alert, the alerts being generated by a machine learning model trained on second historical sensor data of a second time period, including sensor data from sensors monitoring the generator subcomponents;
receiving the health indicators for the gearbox subcomponents and the health indicators for the generator subcomponents; and
displaying a list of the multiple wind turbines, the health indicators for the gearbox subcomponents and the health indicators for the generator subcomponents, the list being sortable by health indicators for the gearbox subcomponents and/or by the health indicators for the generator subcomponents, and the list being filterable by alerts for the gearbox subcomponents and/or alerts for the generator subcomponents.
